(19) United States
(12) Patent Application Publication
(10) Pub. No.: US 2025/0184933 A1
(43) Pub. Date: Jun. 5, 2025

(54) COMPACT SSB AND ASSOCIATED SIGNALING

(71) Applicant: QUALCOMM Incorporated, San Diego, CA (US)

(72) Inventors: Navid ABEDINI, Basking Ridge, NJ (US); Tao LUO, San Diego, CA (US)

(21) Appl. No.: 18/527,196

(22) Filed: Dec. 1, 2023

(51) Int. Cl. H04W 56/00; H04L 5/00; H04W 72/1273; H04W 72/231

(52) U.S. Cl. CPC H04W 56/0015; H04L 5/0051; H04W 72/1273; H04W 72/231

(57) ABSTRACT

A user equipment (UE) may monitor for a compact synchronization signal blocks (SSB) burst set from a first cell on a raster based on a compact SSB pattern associated with the raster; and synchronize with the first cell based on at least one received SSB in the compact SSB burst set. A UE may receive at least one of a SSB or a reference signal in a compact burst set from a network node; receive a physical downlink control channel (PDCCH) transmission for remaining system information (RMSI) in a monitoring occasion that has a fixed location relative to an associated SSB or an associated reference signal in the compact burst set; and receive an RMSI physical downlink shared channel (PDSCH) transmission, wherein the RMSI PDSCH transmission includes information indicating a pattern for the compact burst set.

### INTRODUCTION

The present disclosure relates generally to communication systems, and more particularly, to wireless communication that includes reception of synchronization signal block (SSBs) or other reference signals.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some aspects, the techniques described herein relate to an apparatus for wireless communication at a user equipment (UE), including: one or more memories; and one or more processors coupled to the one or more memories and configured to cause the UE to: monitor for a compact synchronization signal blocks (SSB) burst set from a first cell on a raster based on a compact SSB pattern associated with the raster; and synchronize with the first cell based on at least one received SSB in the compact SSB burst set.

In some aspects, the techniques described herein relate to a method of wireless communication at a UE, including: monitoring for a compact SSB burst set from a first cell on a raster based on a compact SSB pattern associated with the raster; and synchronizing with the first cell based on at least one received SSB in the compact SSB burst set.

In some aspects, the techniques described herein relate to an apparatus for wireless communication at a UE, including: means for monitoring for a compact SSB burst set from a first cell on a raster based on a compact SSB pattern associated with the raster; and means for synchronizing with the first cell based on at least one received SSB in the compact SSB burst set.

In an aspect of the disclosure, a computer-readable medium is provided. The computer-readable medium stores computer executable code at a UE, the code when executed by one or more processors causes the UE to: monitor for a compact SSB burst set from a first cell on a raster based on a compact SSB pattern associated with the raster; and synchronize with the first cell based on at least one received SSB in the compact SSB burst set.

In some aspects, the techniques described herein relate to an apparatus for wireless communication at a UE, including: one or more memories; and one or more processors coupled to the one or more memories and configured to cause the UE to: receive at least one of a SSB or a reference signal in a compact burst set from a network node; receive a physical downlink control channel (PDCCH) transmission for remaining system information (RMSI) in a monitoring occasion that has a fixed location relative to an associated SSB or an associated reference signal in the compact burst set; and receive an RMSI physical downlink shared channel (PDSCH) transmission, wherein the RMSI PDSCH transmission includes information indicating a pattern for the compact burst set.

In some aspects, the techniques described herein relate to a method of wireless communication at a UE, including: receiving at least one of a synchronization signal block (SSB) or a reference signal in a compact burst set from a network node; receiving a PDCCH transmission for RMSI in a monitoring occasion that has a fixed location relative to an associated SSB or an associated reference signal in the compact burst set; and receiving an RMSI PDSCH transmission, wherein the RMSI PDSCH transmission includes information indicating a pattern for the compact burst set.

In some aspects, the techniques described herein relate to an apparatus for wireless communication at a UE, including: means for receiving at least one of a synchronization signal block (SSB) or a reference signal in a compact burst set from a network node; means for receiving a PDCCH transmission for RMSI in a monitoring occasion that has a fixed location relative to an associated SSB or an associated reference signal in the compact burst set; and means for receiving an RMSI PDSCH transmission, wherein the RMSI PDSCH transmission includes information indicating a pattern for the compact burst set.

In an aspect of the disclosure, a computer-readable medium is provided. The computer-readable medium stores computer executable code at a UE, the code when executed by one or more processors causes the UE to: receive at least one of a synchronization signal block (SSB) or a reference signal in a compact burst set from a network node; receive a PDCCH transmission for RMSI in a monitoring occasion that has a fixed location relative to an associated SSB or an associated reference signal in the compact burst set; and receive an RMSI PDSCH transmission, wherein the RMSI PDSCH transmission includes information indicating a pattern for the compact burst set.

In some aspects, the techniques described herein relate to an apparatus for wireless communication at a network node, including: one or more memories; and one or more processors coupled to the one or more memories and configured to cause the network node to: provide multiple synchronization signal blocks (SSBs) in a compact SSB burst set on a raster based on a compact SSB pattern associated with the raster; and communicate with at least one UE after providing the compact SSB burst set.

In some aspects, the techniques described herein relate to a method of wireless communication at a network node, including: providing multiple synchronization signal blocks (SSBs) in a compact SSB burst set on a raster based on a compact SSB pattern associated with the raster; and communicating with at least one UE after providing the compact SSB burst set.

In some aspects, the techniques described herein relate to an apparatus for wireless communication at a network node, including: means for providing multiple synchronization signal blocks (SSBs) in a compact SSB burst set on a raster based on a compact SSB pattern associated with the raster; and means for communicating with at least one UE after providing the compact SSB burst set.

In an aspect of the disclosure, a computer-readable medium is provided. The computer-readable medium stores computer executable code at a network node, the code when executed by one or more processors causes the network node to: provide multiple synchronization signal blocks (SSBs) in a compact SSB burst set on a raster based on a compact SSB pattern associated with the raster; and communicate with at least one user equipment (UE) after providing the compact SSB burst set.

In some aspects, the techniques described herein relate to an apparatus for wireless communication at a network node, including: one or more memories; and one or more processors coupled to the one or more memories and configured to cause the network node to: provide a signal including at least one of a synchronization signal block (SSB) or a reference signal in a compact burst set; provide a PDCCH transmission for RMSI in a monitoring occasion that has a fixed location relative to an associated SSB or an associated reference signal in the compact burst set; and provide an RMSI PDSCH transmission, wherein the RMSI PDSCH transmission includes information indicating a pattern for the compact burst set.

In some aspects, the techniques described herein relate to a method of wireless communication at a network node, including: providing a signal including at least one of a synchronization signal block (SSB) or a reference signal in a compact burst set; providing a PDCCH transmission for RMSI in a monitoring occasion that has a fixed location relative to an associated SSB or an associated reference signal in the compact burst set; and providing an RMSI PDSCH transmission, wherein the RMSI PDSCH transmission includes information indicating a pattern for the compact burst set.

In some aspects, the techniques described herein relate to an apparatus for wireless communication at a network node, including: means for providing a signal including at least one of a synchronization signal block (SSB) or a reference signal in a compact burst set; means for providing a PDCCH transmission for RMSI in a monitoring occasion that has a fixed location relative to an associated SSB or an associated reference signal in the compact burst set; and means for providing an RMSI PDSCH transmission, wherein the RMSI PDSCH transmission includes information indicating a pattern for the compact burst set.

In an aspect of the disclosure, a computer-readable medium is provided. The computer-readable medium stores computer executable code at a network node, the code when executed by one or more processors causes the network node to: provide a signal including at least one of a synchronization signal block (SSB) or a reference signal in a compact burst set; provide a PDCCH transmission for RMSI in a monitoring occasion that has a fixed location relative to an associated SSB or an associated reference signal in the compact burst set; and provide an RMSI PDSCH transmission, wherein the RMSI PDSCH transmission includes information indicating a pattern for the compact burst set.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a base station in communication with a UE in an access network, in accordance with various aspects of the present disclosure.

FIG. 5A illustrates an example of a non-compact SSB burst set pattern.

FIG. 5B illustrates an example of a non-compact SSB burst set pattern, in accordance with aspects of the present disclosure.

FIG. 6A illustrates an example association between synchronization rasters and compact SSB patterns, in accordance with aspects of the present disclosure.

FIG. 6B illustrates and example communication flow between a network node and a UE, in accordance with aspects of the present disclosure.

FIG. 7A and FIG. 7B illustrate example communication flows between a network node and a UE, in accordance with aspects of the present disclosure.

FIG. 8A illustrates and example communication flow between a network node and a UE, in accordance with aspects of the present disclosure.

FIG. 8B illustrates example multiplexing patterns for transmitting SSB, PDCCH, and a CORESET, in accordance with aspects of the present disclosure.

FIG. 9A and FIG. 9B illustrate example communication flows between a network node and a UE, in accordance with aspects of the present disclosure.

FIG. 10 is a flowchart of a method of wireless communication at a UE, in accordance with aspects of the present disclosure.

FIG. 11 is a flowchart of a method of wireless communication at a UE, in accordance with aspects of the present disclosure.

FIG. 12 is a flowchart of a method of wireless communication at a network node, in accordance with aspects of the present disclosure.

FIG. 13 is a flowchart of a method of wireless communication at a network node, in accordance with aspects of the present disclosure.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

A network node, such as a base station or one or more components of a base station may periodically transmit an SSB to enable UEs to determine information about a cell. For example, the SSB may enable the UE to determine cell timing information, a cell identity, and system information for the cell. The UE may use the SSB for initial cell acquisition, cell selection, cell reselection, radio resource management (RRM) measurements, and/or mobility measurements.

Sets of SSBs may be transmitted in patterns having gaps in time that allow time resources for other wireless traffic. In some aspects, the time gaps allow for coexistence with other radio access technologies. An “SSB burst set” may refer to a set of SSB occasions, or SSB transmissions, within a period of time. As one, non-limiting example, the period of time may be 20 ms, and up to 64 SSBs occasions may be provided within the 20 ms time period as part of the SSB burst set. The pattern of the SSB occasions within the SSB burst set may be referred to as an “SSB burst set pattern.” In some aspects, there may not be a load of traffic for the cell transmitting the SSB burst set, or there may be a lower amount of traffic to be served by the cell. In some aspects, a cell may save power by transmitting SSBs with a modified configuration to reduce or compress the time-domain resources of periodic SSBs and enable the network node to remain in a power saving or sleep mode for longer durations. The longer duration in the power saving mode may enable the network node to enter a deeper sleep mode having a higher amount of power savings, for example. As an example, for power saving, the network node may transmit a compact SSB burst set pattern having a smaller time gaps between SSBs, an increased number of consecutive SSBs, or a more compact or dense grouping placement of SSBs in time, when compared with a non-compact or default SSB pattern.

A UE determines timing for a cell, e.g., synchronizes with the cell, based on the SSBs that the UE receives. For example, the UE may identify a slot or symbol using the received SSB. If the network node uses a compact SSB burst set pattern, the SSB placement may be different, and there may be a problem in which the UE may not be able to accurately determine timing for the cell, such as a slot timing or symbol timing. For example, the UE may determine slot boundary or a symbol boundary, and may identify a slot index and/or a symbol index as part of determining the timing for the cell. Aspects presented herein enable power savings at the cell and/or UE, such as through the use of compact SSB burst set patterns, while also providing mechanisms for the UE to determine accurate timing information from an SSB received in the compact pattern.

In some aspects, the compact SSB burst set pattern may be a defined, raster specific pattern. This enables the UE to determine the pattern of SSBs in the compact SSB burst set pattern according to the synchronization raster on which the UE receives the SSB. A “synchronization raster” corresponds to frequency interval, or location, at which SSBs may potentially be transmitted. With the knowledge of the pattern, the UE can accurately determine timing and synchronize with the cell.

Additionally, or alternatively, information about the compact SSB burst set pattern may be signaled to the UE, such as in radio resource control (RRC) signaling, system information (such as a SIB or MIB), and/or in operations, administration, and management (OAM) signaling to the UE. The signaled pattern may be raster specific, for example. By providing the UE with the pattern information, the network enables the UE to determine accurate timing information from the SSBs.

Additionally, or alternatively, the network may provide compact SSB burst set pattern information in RMSI associated with an SSB. For example, the network may transmit PDCCH for the RMSI at a fixed location relative to the SSB, and the PDCCH transmission may indicate the resources for a PDSCH transmission with the RMSI that carries the pattern information. This enables the UE to obtain the pattern information with the SSB, and enables initial access to the cell without prior knowledge of the compact SSB burst set pattern. As an example, the indication of the pattern in the RMSI enables the power saving compact SSB burst set to be used for a standalone/non-assisted use-case without additional loading on a master information block (MIB) in an SSB.

Additionally, or alternatively, the DMRS sequence generation, e.g., transmitted with the RMSI, may be independent of a slot or symbol index. For example, the initialization value for the DMRS sequence generation may be based on a fixed value, a previously configured value, or a value that is indicated to the UE. As an example, the DMRS sequence generation may be based on an SSB index, e.g., rather than a slot or symbol index. This enables the UE to receive and decode the DMRS even if the UE has not yet determined the slot or symbol index.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

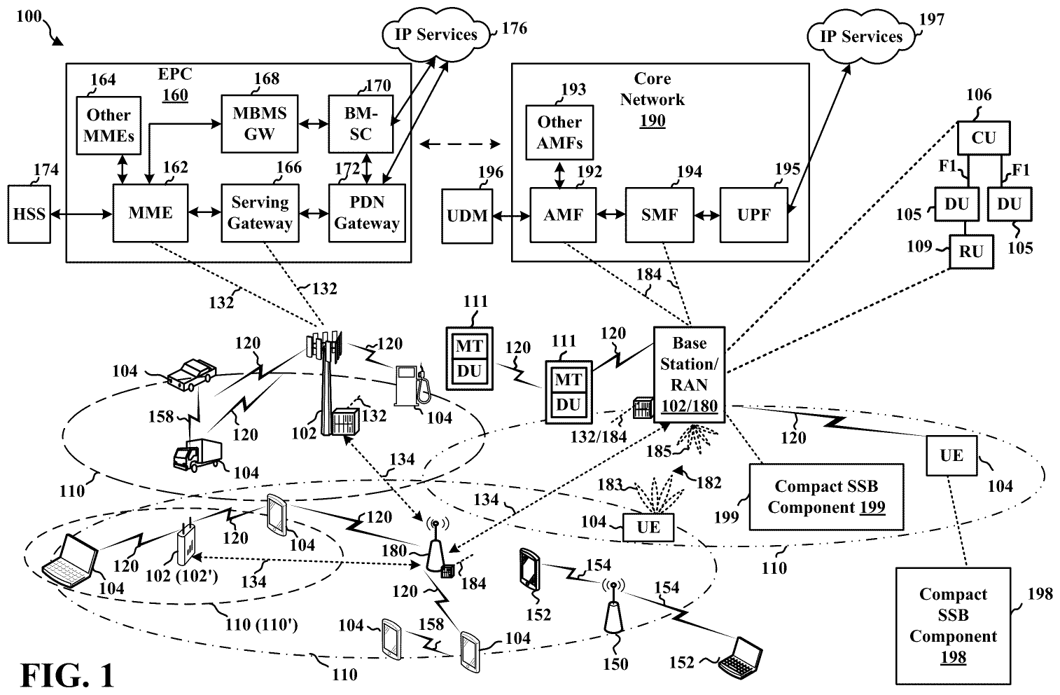

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHZ, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 185. The UEs 104 may receive the beamformed signal from the base stations 180 in one or more receive directions 183. The UEs 104 may also transmit a beamformed signal to the base stations 180 in one or more transmit directions (e.g., 183). The base stations 180 may receive the beamformed signal from the UEs 104 in one or more receive directions (e.g., 185). The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the UE 104 may include a compact SSB component 198 configured to monitor for a compact SSB burst set from a first cell on a raster based on a compact SSB pattern associated with the raster; and synchronize with the first cell based on at least one received SSB in the compact SSB burst set. In some aspects, the compact SSB component 198 may be configured to receive at least one of a synchronization signal block (SSB) or a reference signal in a compact burst set from a network node; receive a PDCCH transmission for RMSI in a monitoring occasion that has a fixed location relative to an associated SSB or an associated reference signal in the compact burst set; and receive an RMSI PDSCH transmission, wherein the RMSI PDSCH transmission includes information indicating a pattern for the compact burst set.

In some aspects, a base station 102 or 180 may include a compact SSB component 199 configured to provide multiple synchronization signal blocks (SSBs) in a compact SSB burst set on a raster based on a compact SSB pattern associated with the raster; and communicate with at least one UE after providing the compact SSB burst set. In some aspects, the compact SSB component 199 may be configured to provide a signal including at least one of a synchronization signal block (SSB) or a reference signal in a compact burst set; provide a PDCCH transmission for RMSI in a monitoring occasion that has a fixed location relative to an associated SSB or an associated reference signal in the compact burst set; and provide an RMSI PDSCH transmission, wherein the RMSI PDSCH transmission includes information indicating a pattern for the compact burst set.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

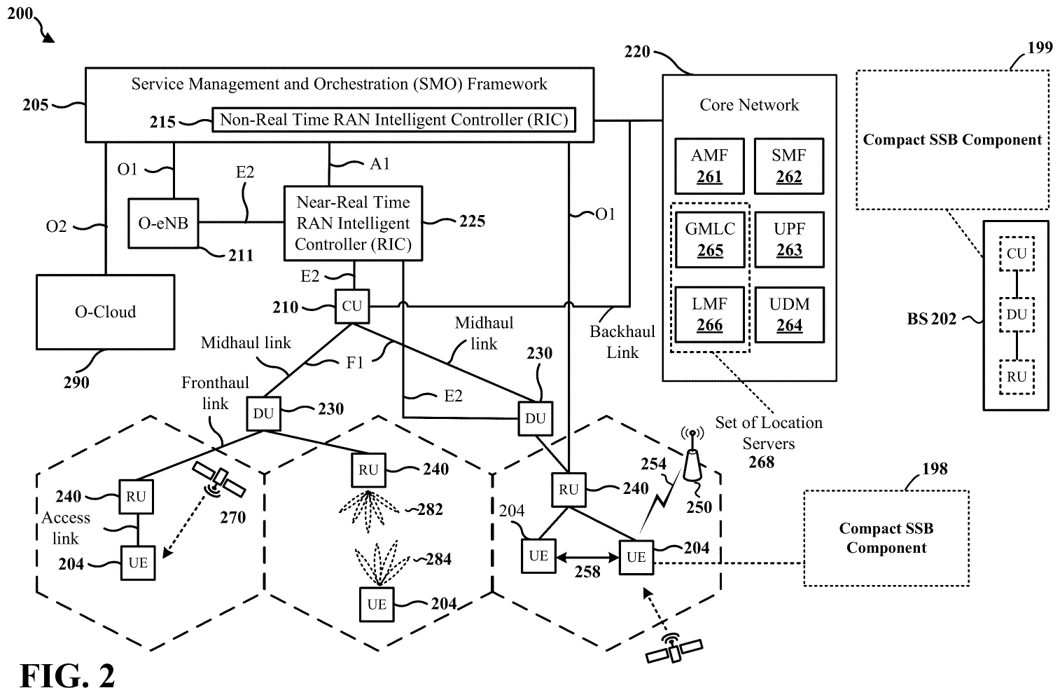

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUS (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar to the UE 104 in FIG. 1, may have a compact SSB component 198 configured to monitor for a compact SSB burst set from a first cell on a raster based on a compact SSB pattern associated with the raster; and synchronize with the first cell based on at least one received SSB in the compact SSB burst set. In some aspects, the compact SSB component 198 may be configured to receive at least one of a synchronization signal block (SSB) or a reference signal in a compact burst set from a network node; receive a PDCCH transmission for RMSI in a monitoring occasion that has a fixed location relative to an associated SSB or an associated reference signal in the compact burst set; and receive an RMSI PDSCH transmission, wherein the RMSI PDSCH transmission includes information indicating a pattern for the compact burst set.

In some aspects, a base station 202, or one or more components of the base station 202, may include a compact SSB component 199 configured to provide multiple synchronization signal blocks (SSBs) in a compact SSB burst set on a raster based on a compact SSB pattern associated with the raster; and communicate with at least one UE after providing the compact SSB burst set. In some aspects, the compact SSB component 199 may be configured to provide a signal including at least one of a synchronization signal block (SSB) or a reference signal in a compact burst set; provide a PDCCH transmission for RMSI in a monitoring occasion that has a fixed location relative to an associated SSB or an associated reference signal in the compact burst set; and provide an RMSI PDSCH transmission, wherein the RMSI PDSCH transmission includes information indicating a pattern for the compact burst set.

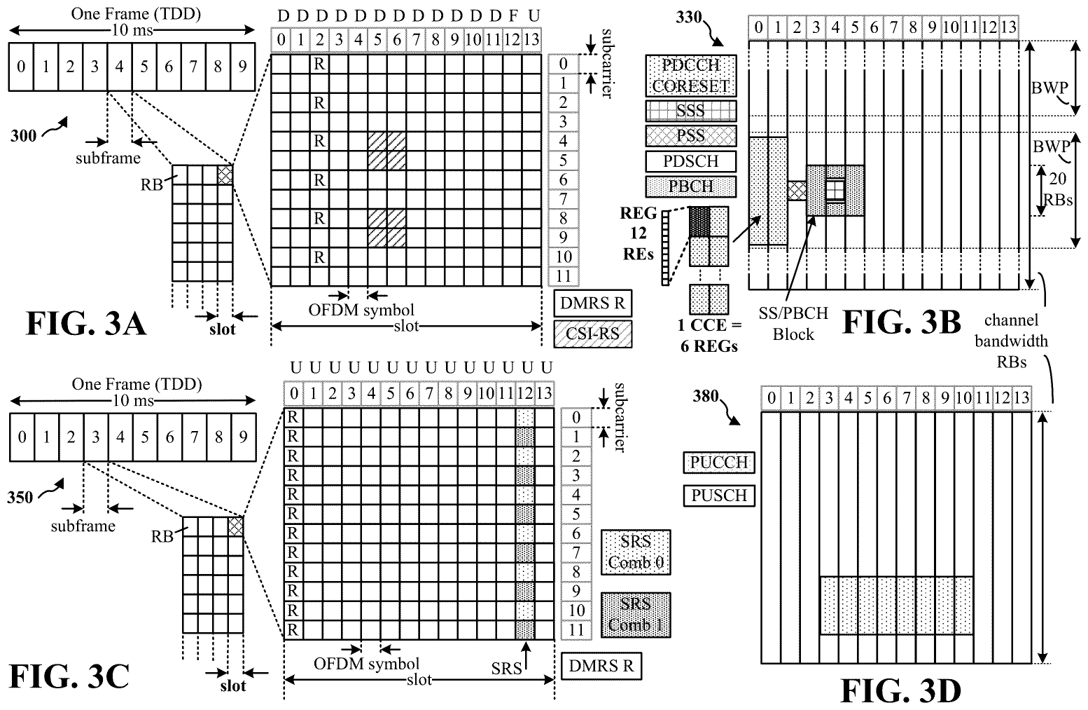

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. As shown in Table 1, the subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The PDCCH carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The PDSCH carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

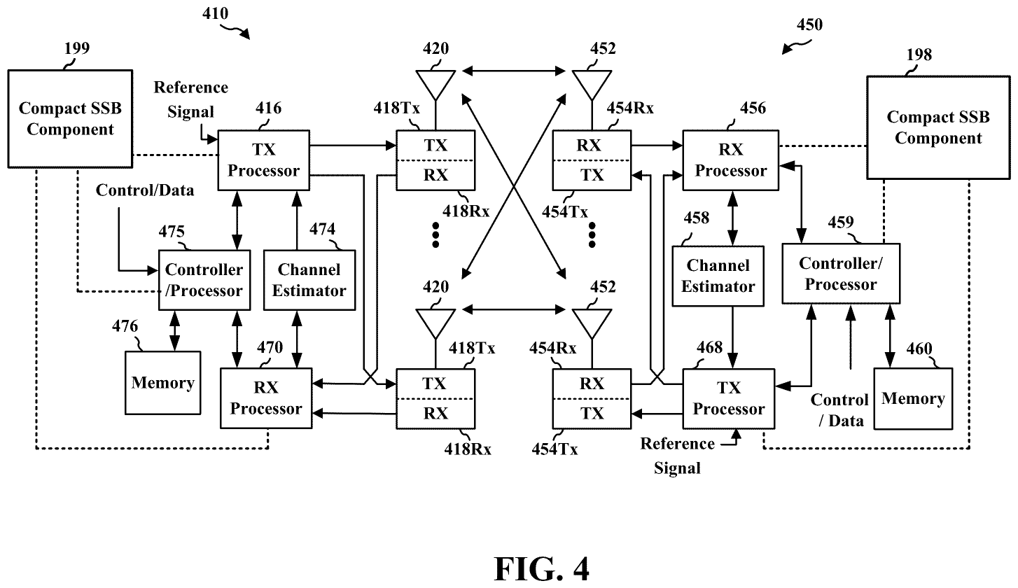

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the compact SSB component 198 of FIG. 1 or FIG. 2.

At least one of the TX processor 416, the RX processor 470, and the controller/processor 475 may be configured to perform aspects in connection with the compact SSB component 199 of FIG. 1 or FIG. 2.

Some wireless communication system may employ network energy saving aspects, and may provide network energy saving (NES) cells or cells that support energy savings or energy saving modes. Such cells may use signaling that is configured to save energy at the network and/or UEs.

As described in connection with FIG. 3B, a base station may transmit an SSB to enable UEs to determine information about a cell, including timing information, cell identity, and system information. FIG. 3B illustrates an example SSB including a PSS, SSS, and PBCH. A UE may perform a cell search to obtain time and/or frequency synchronization with a cell (e.g., a base station) and to obtain a cell identifier (ID), such as physical layer cell ID (PCI) of the cell. The UE may also learn the signal quality and other information about the cell based on the PCI. The UE may perform the cell search for a defined frequency range before the UE selects or re-selects a cell. In some examples, a UE may perform the cell search when the UE is powered ON, when the UE is moving (e.g., under the mobility in connected mode), and/or when the UE is in an idle/inactive mode (e.g., the UE may perform a cell reselection procedure after the UE camps on a cell in the idle mode).

To perform the cell search (e.g., the initial cell search and/or the cell reselection, etc.), a UE may decode synchronization signal(s) transmitted from one or more cells, where the UE may obtain or derive information related to the one or more cells and/or their access information based on the synchronization signal(s). In one example, a cell may transmit one or more types of synchronization signals, such as a primary synchronization signal (PSS) and a secondary synchronization signal (SSS), along with a physical broadcast channel (PBCH), in a synchronization signal block (SSB) for UEs within its transmission range, e.g., as described in connection with FIG. 3B. The UE may perform the cell search by monitoring for the SSBs. In some examples, a UE may first decode a PBCH before the UE may receive other system information transmitted on a physical downlink shared channel (PDSCH).

As shown in the example in FIG. 3B, an SSB may span four OFDM symbols with one symbol for a PSS, two symbols for PBCH, and one symbol with an SSS and PBCH that are frequency division multiplexed (FDMed). The length of an OFDM symbol or a slot may be scaled with subcarrier spacing (SCS), and there may be seven or fourteen symbols per slot. For example, different frequency ranges may have different SCS, where 15, 30, and/or 60 kHz SCS may be used for the lower frequency bands (e.g., the FR1), and 60, 120, and/or 240 kHz SCS may be used for the higher frequency bands (e.g., the FR2). In one example, the PSS may be mapped to 127 subcarriers (SCs) around the center frequency of the SSB, where the PSS may use a length 127 frequency domain-based M-sequence (e.g., made up of 127 M-sequence values), which may have up to three possible sequences. The M-sequence may also be referred to as a maximum length sequence (MLS), which may be a type of pseudorandom binary sequence. The SSS may also be mapped to 127 SCs and may use a length 127 frequency domain-based Gold Code sequence (e.g., two M-sequences are used), which may have up to 1008 possible sequences. A UE may use the information included in the PSS and/or the SSS for downlink frame synchronization and for determining the physical cell ID of the cell. The PBCH and/or may be modulated with quadrature phase shift keying (QPSK), which may be coherently demodulated by a UE using the associated DMRS carried in the PBCH. The PBCH and/or may include the master information block (MIB) part of the MAC layer broadcast channel (BCH). The other part of the BCH, such as the system information block (SIB), may be included in a PDSCH allocation encoded with the system information-radio network temporary identifier (SI-RNTI).

During an initial cell search or a cell reselection, a UE searching for a cell may use a sliding window and correlation technique to look for the PSS in the SSB. For example, the UE may use a sliding window with a length of one symbol to try to correlate one or more possible PSS sequences as the UE may not know which subcarriers carry the PSS. In addition, due to the Doppler, internal clock frequency shifts, and/or other frequency errors associated with the PSS, the UE may use different timing hypothesis and/or frequency hypothesis to account for these errors. For example, for each timing hypothesis, the UE may try to use all three sequences+N frequency hypothesis to account for the Doppler, internal clock frequency shifts, and any other frequency errors.

The UE may use the SSB to determine timing and/or frequency offset estimations. The UE decodes the PSS to determine the estimated timing and/or frequency for the SSS associated with the PSS. Then, the UE may search for or correlate the associated SSS based on the estimated timing and/or frequency. For example, the UE uses the PSS to determine subframe/symbol timing and a physical layer identity. The SSS may be within symbol 4 of particular subframes of a frame, for example, and the UE may use the SSS to determine a physical layer cell identity group number and radio frame timing. The SSS may include a cell ID. Based on the PSS and the SSS, the UE may determine the timing and/or frequency of the PBCH. The PBCH may carry the MIB and DMRS, and the PBCH may be modulated with QPSK. The UE may perform coherent demodulation of the PBCH based on the DMRS carried in the PBCH. In addition, the UE may use the DMRS to perform channel estimation. In one example, the DMRS may carry, or be used by the UE to determine, three (3) least significant bits (LSB) (e.g., for the FR2) of an SSB index per half frame from a DMRS sequence index. For example, under the FR2, a base station or one or more transmission reception points (TRPs) of a base station may communicate with a UE using more than one beam (e.g., up to 64 beams), where each beam may correspond to one beam index. In some examples, each beam index may further be associated with an SSB index, such that the base station may indicate to the UE which beam(s) may be used by the base station for transmission through the SSB index. As an example, a base station or TRP(s) of a base station may use up to 64 beams, the SSB index may be six bits long (e.g., 26=64), where three bits may be carried in the DMRS, and the other three bits may be multiplexed with the PBCH. In some examples, the DMRS may be interleaved (e.g., in frequency) with the PBCH data. The UE may use the DMRS, the SSS and/or the PSS signals in an SSB to refine the frequency offset estimation.

The PBCH may include one or more parameters that may be used by a UE to decode a system information block type one (SIB1) message (e.g., SIB1 PDSCH). For example, the MIB within the PBCH may carry a field (e.g., which may be referred to as a pdcch-ConfigSIBI field) that includes a parameter for an initial CORESET (e.g., a controlResourceSetZero parameter) and a parameter for an initial search space set (e.g., a searchSpaceZero parameter). The controlResourceSetZero parameter may guide the UE to a CORESETO, where the CORESETO may carry a PDCCH that has information for scheduling a SIB1 PDSCH. For example, the UE may use the controlResourceSetZero parameter to determine a multiplexing pattern and the CORESETO's frequency offset, number of resource blocks (RBs) and/or number of symbols. The UE may use a search space parameter (e.g., which may be referred to as a searchSpaceZero parameter) to determine the CORESETO's time location. Thus, based on the information included in the controlResourceSetZero parameter and/or the searchSpaceZero parameter, the UE may identify or determine the location (e.g., in time and/or frequency) of the CORESETO.

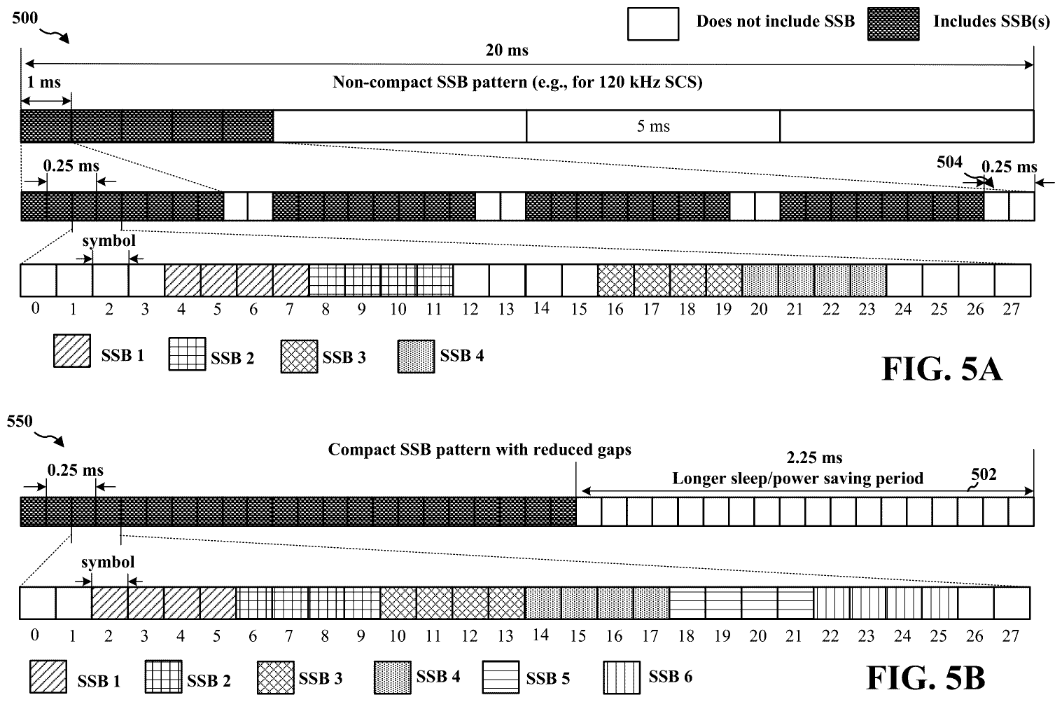

A UE may monitor for SSBs based on sets of multiple SSBs. The set of multiple SSBs may be referred to as an SSB burst set. There may be multiple SSB burst set patterns. FIG. 5A and FIG. 5B illustrate example SSB burst set patterns. FIG. 5A illustrates a time diagram 500 with a pattern for an SSB burst set within a 20 ms time period. As shown in FIG. 5A, 5 ms within the 20 ms may include SSBs, and the remaining 15 ms may be a time gap between SSBs. FIG. 5A further illustrates that within the 5 ms containing the SSBs of the SSB burst set, there may be additional gaps provided, e.g., 0.25 ms gaps between 1 ms periods that do include SSBs. Each 0.25 ms period that includes SSBs, may span a set of 28 symbols (e.g., shown as symbols 0-27). FIG. 5A illustrates a pattern with a gap of 4 symbols (symbols 0-3) that do not include an SSB, followed by the consecutive transmission of two SSBs (e.g., SSB 1 on symbols 4-7 and SSB 2 on symbols 8-11). A gap (at symbols 12-15) without SSBs is provided at symbols 12-15, followed by the consecutive transmission of SSB 3 on symbols 16-17 and SSB 4 on symbols 20-23. The time period ends with a gap without symbols on symbols 24-27. In some examples, the period of time may correspond to a 20 ms period. Although the symbol level pattern is only illustrated in FIG. 5A for a single 0.25 ms period, the SSB burst set may correspond to the 20 ms time period, with SSBs transmitted using a similar, or repeating, pattern throughout the 5 ms period shown, e.g., for up to 64 SSBs in the 20 ms period. An SSB burst set may refer to a set of SSB occasions, or SSB transmissions, within a period of time.

The pattern of SSBs within the SSB burst set may be fixed, e.g., and defined in a wireless standard. In some aspects, different patterns may be provided for different subcarrier spacings (SCS). The example in FIG. 5A may correspond to a pattern for a 120 kHz SCS, for example.

The gaps in the SSB burst set pattern allow time resources for other wireless traffic. In some aspects, the time gaps allow for coexistence with other radio access technologies, e.g., such as LTE in FR1. In some aspects, there may not be a load of traffic for the cell that is transmitting the SSB burst set, or there may be a low amount of traffic to be served by the cell. In some aspects, a base station may save power by entering into an energy or power saving mode for a duration. For example, for cells operating in an energy saving mode may transmit/broadcast SSBs with modified configurations to reduce the time-domain footprint of periodic SSBs and enable the base station to remain for longer durations in an energy saving mode.

FIG. 5B illustrates an example time diagram 550 including a compact SSB burst set having a more compact pattern of SSB occasions within the SSB burst set. The more compact SSB pattern enables an SSB sweep pattern that is more compact in time, e.g., with fewer and/or shorter time gaps between consecutive SSB occasions. FIG. 5B illustrates a higher number of consecutive SSB occasions, e.g., without one or more gap symbols between SSB occasions, in comparison to the number of consecutive SSB occasions shown in the pattern in FIG. 5A. As shown at 502, the denser pattern of SSB occasions in the SSB burst set enables a longer sleep period (or power saving period) 502 in comparison to the periods shown without SSB occasions in FIG. 5A. For example, the compact SSB burst set pattern in FIG. 5B includes a 2.25 ms duration at 502 in comparison to the 0.25 ms duration shown at 504 in FIG. 5A. In some aspects, the SSB burst set pattern in FIG. 5A may be referred to as a non-compact SSB burst set. In some aspects, the SSB pattern in FIG. 5A may be referred to as a default SSB burst set pattern, e.g., for a particular SCS, in contrast to a compact SSB burst set pattern

In some aspects, a cell (which may be referred to as a network energy saving (NES) cell or a cell in an NES mode) that transmits SSBs based on a compact SSB burst set pattern may not serve UEs using the compact SSB transmissions if the UEs do not support a capability for compact SSB burst set reception. In some aspects, the cell may still be accessed by such UEs as an SSB-less SCell having an anchor serving cell that provides a non-compact SSB. Compact SSB burst set patterns may not be transmitted on the same synchronization rasters as non-compact SSB burst set patterns, as it may cause confusion to the UEs. For example, a UE that does not support a compact SSB burst set pattern may receive an SSB based on the compact burst set pattern, and may inaccurately determining timing for the cell according to a non-compact SSB burst set pattern. For example, if a UE received the SSB 4 shown in the compact SSB burst set pattern of FIG. 5B, the UE may determine a timing based on symbols 20-23 for SSB 4 in FIG. 5A under the assumption that a non-compact SSB burst set pattern is used, whereas SSB 4 is actually transmitted at symbols 14-17 in the compact SSB burst set pattern of FIG. 5B. The UE may inaccurately map the received SSB to an incorrect slot index and/or may determine an incorrect slot or symbol boundary. With the timing inaccuracy, the UE is not correctly synchronized with the cell and may monitor for downlink communication at incorrect times and/or attempt to transmit to the network at inaccurate times.

Aspects presented herein enable the use of compact SSB burst set patterns in various settings. In a first example, a compact SSB burst set pattern may be used by a UE for connected mode radio resource management (RRM) measurements and/or mobility measurements and determinations (e.g., measurements of SCells and neighbor cells). With a connection to the cell, the cell may provide the UE with information about the compact SSB burst set pattern that enables the UE to use the SSBs in the pattern for RRM and mobility measurements. For example, the cell may indicate the frequency of the cell (e.g., a center frequency of the SSBs in the compact SSB burst set pattern) and/or the pattern of SSB occasions in the SSB burst set (e.g., which may be referred to as an SSB burst set pattern or a compact SSB burst set pattern).

In another example, a compact SSB burst set pattern may be used by a UE for cell selection and/or cell reselection using information previously stored by the UE. In some aspects, this may be referred to as an assisted mode, e.g., and the UE may use compact SSB burst set pattern information either received from the cell when the UE had a previous connection to the cell and/or receive from a second cell to assist the UE in its reception of the SSB from the cell.

In another example, a compact SSB burst set pattern may be used by a UE for initial cell selection, e.g., without stored information about the compact SSB burst set pattern. In some aspects, this may be referred to as a non-assisted mode.

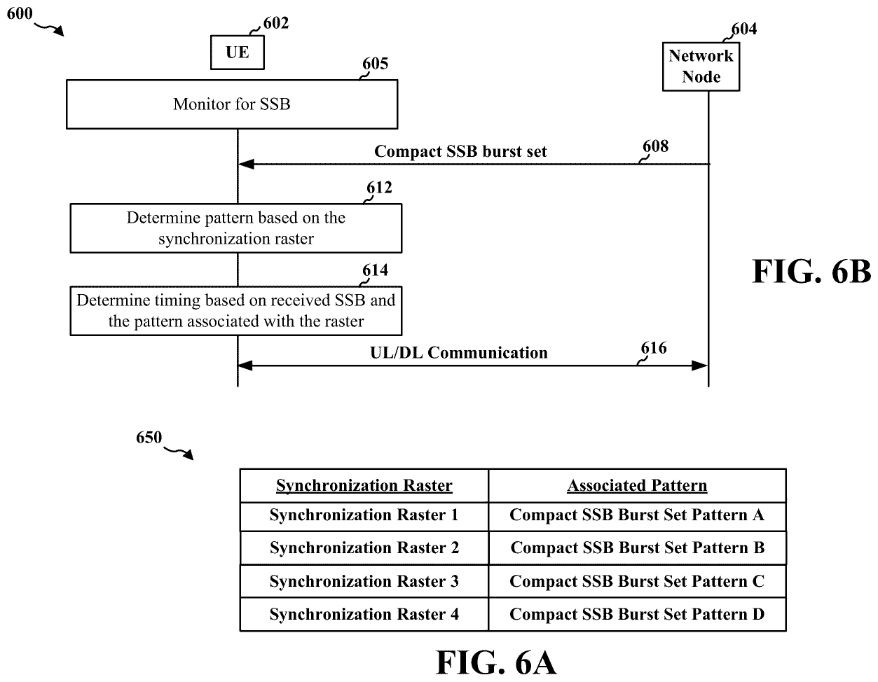

Aspects presented herein provide various example mechanisms for providing SSB pattern indications or information to UEs. In some examples, the compact SSB burst set pattern may be fixed and may be raster specific. As an example, an association between a compact SSB burst set pattern and a synchronization raster may be defined, such as in a wireless standard. FIG. 6A illustrates an example table 650 showing a set of synchronization rasters, each synchronization raster having an associated compact SSB burst set pattern. The defined association enables a UE to know the corresponding pattern when monitoring for an SSB on a particular raster. As the pattern is defined for the particular raster, the synchronization rasters for the compact SSB burst set pattern may be different than synchronization rasters for a non-compact SSB pattern, e.g., dedicated for the compact SSB burst set pattern. As the UE is aware of the pattern, once the UE receives an SSB from the burst set, the UE can accurately determine timing (such as a slot and symbol timing).

FIG. 6B illustrates an example communication flow 600 between a UE 602 and a network node 604 that provides a cell. The network node may be a base station (e.g., base station 102, 202, 410) in aggregated form or one or more components of a disaggregated base station, such as a CU 210, DU 230, and/or RU 240. The network node 604 transmits SSBs in a compact SSB burst set. The compact SSB burst set may include a pattern such as the pattern illustrated in FIG. 5B, as one example. The compact SSB burst set may also have a different pattern that has a decreased time gaps between SSBs, an increased number of consecutive SSBs, or a more compact or dense grouping placement of SSBs in time, when compared with a non-compact or default SSB pattern. The compact burst set pattern for the SSBs is a defined pattern (e.g., defined in a wireless standard) based on the synchronization raster on which the SSBs are transmitted. As an example, if the SSBs are transmitted on synchronization raster 1 from FIG. 6A, the pattern will be compact SSB burst set pattern A, as shown in the table in FIG. 6A. The UE 602 monitors for an SSB on a synchronization raster, at 605. The UE may receive at least one SSB from the compact SSB burst set 608 transmitted by the network node 604. As shown at 612, the UE may determine the pattern of the compact SSB burst set that is defined for the synchronization raster that the UE is monitoring. Then, at 614, the UE can determine timing (e.g., symbol and/or slot timing) for the cell based on the known pattern and the SSB(s) that the UE received. For example, the UE may receive or determine index information from the SSB (e.g., an SSB index and/or beam index associated with the SSB). From the compact SSB burst set pattern, the UE may identify a slot and/or symbol in which the corresponding SSB (with the SSB index or beam index) is transmitted by the network node.

By accurately determining the timing, the UE is able to synchronize with the cell. This enables the UE to receive downlink communication and/or transmit uplink communication with the network node 604, as shown at 616, based on the accurately determined timing. As well, accurately determining a slot/symbol timing may enable the UE to correctly determine a DMRS sequence, e.g., for PDCCH and/or PDSCH, which may be based on a slot and/or symbol index.

In some aspects, the fixed, raster specific compact SSB burst set patterns can enable a UE to perform initial access to a cell, e.g. in an unassisted mode in which the UE is not signaled pattern information in advance of searching for the cell. This enables the UE to make an initial cell selection. In some aspects, the fixed, raster specific compact SSB burst set patterns can enable a UE to perform cell selection and/or reselection that is not an initial access. In some aspects, the fixed, raster specific compact SSB burst set patterns can enable a UE to perform connected mode RRM and/or mobility measurements (e.g., for the cell as an SCell or neighbor cell).

In some aspects, the compact SSB burst set pattern may be signaled to the UE to enable the UE to accurately synchronize with the cell, e.g., make accurate timing determinations based on received SSBs within the pattern. Providing the UE with the pattern information enables a UE to perform cell selection and/or reselection, e.g., that is not an initial access. The cell selection or reselection may be referred to as an assisted mode cell selection/reselection, because it is performed using information provided to the UE. The information may be provided to the UE by a serving cell (e.g., the UE may use pattern information that it previously received from the cell). In some aspects, providing the UE with the pattern information can enable a UE to perform connected mode RRM and/or mobility measurements (e.g., for the cell as an SCell or neighbor cell).

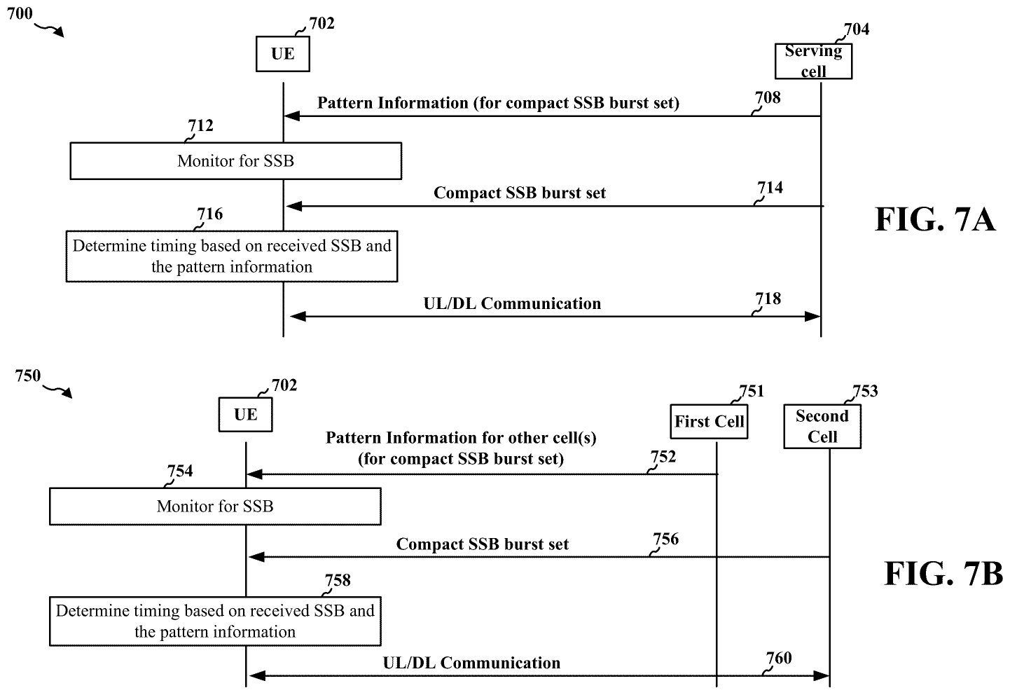

FIG. 7A illustrates an example communication flow 700 between a UE 702 and a network node that provides a cell 704 (which may be referred to as a serving cell that serves the UE). The network node may be a base station (e.g., base station 102, 202, 410) in aggregated form or one or more components of a disaggregated base station, such as a CU 210, DU 230, and/or RU 240.

As shown at 708, the serving cell 704 provides the UE 702 with pattern information at least for a compact SSB burst set transmitted by the serving cell. In some aspects, the pattern may be specific to a particular synchronization raster. For example, the serving cell 704 may transmit an indication of the pattern information to the UE 702. The pattern information indicates the SSB burst set pattern, and may further indicate a center frequency of the SSBs, for example. As an example, a pattern for a compact SSB burst set may be indicated in various ways. In an example, there may be a set of patterns (e.g., either configured prior to the indication at 708 or defined in a wireless standard), and the indication may indicate a pattern from the set of patterns. For example, the indication of the pattern information may include an index that refers to a configured or defined compact SSB burst set pattern. In some examples, the pattern may be characterized by a set of one or more parameters, and the indication at 708 may indicate one or more of the parameters to the UE. For example, the parameters may include an offset (e.g., a location of a first SSB), a number of consecutive SSBs in a group within the SSB burst set, a number of groups of consecutive SSBs in the SSB burst set, and/or a time interval value between groups of consecutive SSBs in the SSB burst set. The serving cell 704 may indicate the pattern information in an RRC message to the UE 702. The serving cell 704 may indicate the pattern information to the UE in system information, such as in a SIB. As an example, the pattern information 708 may be in SIB2, SIB3, or SIB4. The cell 704 may periodically broadcast the system information with the compact SSB burst set pattern information, or the system information may be provided to the UE 702 in response to a request. As an example, the cell 704 may indicate that it has compact SSB burst set pattern information, and the UE may respond with a request (e.g., in a RACH transmission) for the information before the cell 704 provides the pattern information 708. The serving cell 704 may signal the pattern information 708 to the UE 702 in OAM signaling. As an example, the UE 702 may receive a configuration of a frequency, cell ID, and burst composition for one or more cells.

In some aspects, the pattern information may enable inter-frequency cell selection/reselection. For example, the pattern information may be used by a UE in an RRC idle or RRC inactive state. In some aspects, the information may provide an association a frequency and a compact SSB burst set pattern for each of one or more frequencies. As an example, any cell operating on a particular frequency may use the associated compact SSB burst set pattern to transmit SSBs.

The UE 702 monitors for an SSB on a synchronization raster, at 712. The UE may monitor for an SSB based on the pattern information 708 that the UE received, for example. The UE may receive at least one SSB from the compact SSB burst set 714 transmitted by the cell 704. As shown at 716, the UE can synchronize with the cell 704 by determining timing (e.g., symbol and/or slot timing) for the cell based on the indicated pattern and the SSB(s) that the UE received. By accurately determining the timing, the UE 702 is able to synchronize with the cell 704. This enables the UE to receive downlink communication and/or transmit uplink communication with the cell 704, as shown at 718, based on the accurately determined timing. As well, accurately determining a slot/symbol timing may enable the UE to correctly determine a DMRS sequence, e.g., for PDCCH and/or PDSCH, which may be based on a slot and/or symbol index.

In some aspects, the pattern information for a first cell may be provided to the UE by a second cell (e.g., as a neighbor cell or a PCell). FIG. 7B illustrates an example communication flow 750 between a UE 702, a first cell 751, and a second cell 753. The cells may be provided by one or more network nodes. A network node may be a base station (e.g., base station 102, 202, 410) in aggregated form or one or more components of a disaggregated base station, such as a CU 210, DU 230, and/or RU 240.

As shown at 752, the serving cell 751 provides the UE 702 with pattern information for a compact SSB burst set of a second cell 753. In some aspects, the pattern may be specific to a particular synchronization raster. The second cell 753 may be an SCell, and the first cell 751 may be a PCell, in some aspects. In some aspects, the second cell 753 may be a neighbor cell to the first cell 751. In some aspects, the first cell 751 may provide compact SSB burst set pattern information for a plurality of cells, e.g., including the second cell 753. For example, the first cell 751 may transmit an indication of the pattern information to the UE 702 for one or more neighbor cells. The pattern information 752 indicates the compact SSB burst set pattern, and may further indicate a center frequency of the SSBs, for example. As described in connection with FIG. 7A, the pattern information may indicate a pattern from a set of patterns or may indicate one or more parameters that correspond to the pattern. The serving cell 751 may indicate the pattern information to the UE 702 in system information, such as in a SIB. As an example, the pattern information 708 may be in SIB2, SIB3, or SIB4. The first cell 751 may periodically broadcast the system information with the compact SSB burst set pattern information, or the system information may be provided to the UE 702 in response to a request. As an example, the first cell 751 may indicate that it has compact SSB burst set pattern information for one or more other cells, and the UE may respond with a request (e.g., in a RACH transmission) for the information before the first cell 751 provides the pattern information 752. The first cell 751 may signal the pattern information 752 to the UE 702 in OAM signaling. As an example, the UE 702 may receive a configuration of a frequency, cell ID, and burst composition for one or more cells.

At 754, the UE 702 monitors for an SSB from the second cell 753, e.g., on a synchronization raster. The UE may monitor for an SSB based on the pattern information 752 that the UE received from the first cell 751, for example. The UE may receive at least one SSB from the compact SSB burst set 756 transmitted by the second cell 753. As shown at 758, the UE can synchronize with the second cell 753 by determining timing (e.g., symbol and/or slot timing) for the second cell based on the indicated pattern and the SSB(s) that the UE received. By accurately determining the timing, the UE 702 is able to synchronize with the second cell 753. This enables the UE to receive downlink communication and/or transmit uplink communication with the second cell 753, as shown at 760, based on the accurately determined timing. As well, accurately determining a slot/symbol timing may enable the UE to correctly determine a DMRS sequence, e.g., for PDCCH and/or PDSCH, which may be based on a slot and/or symbol index.

In some aspects, the UE may receive pattern information for the compact SSB burst set in information that is multiplexed with the SSB. As an example, a network node may transmit an SSB, and may include the pattern information in remaining minimum system information (RMSI) that is transmitted in association with the SSB.

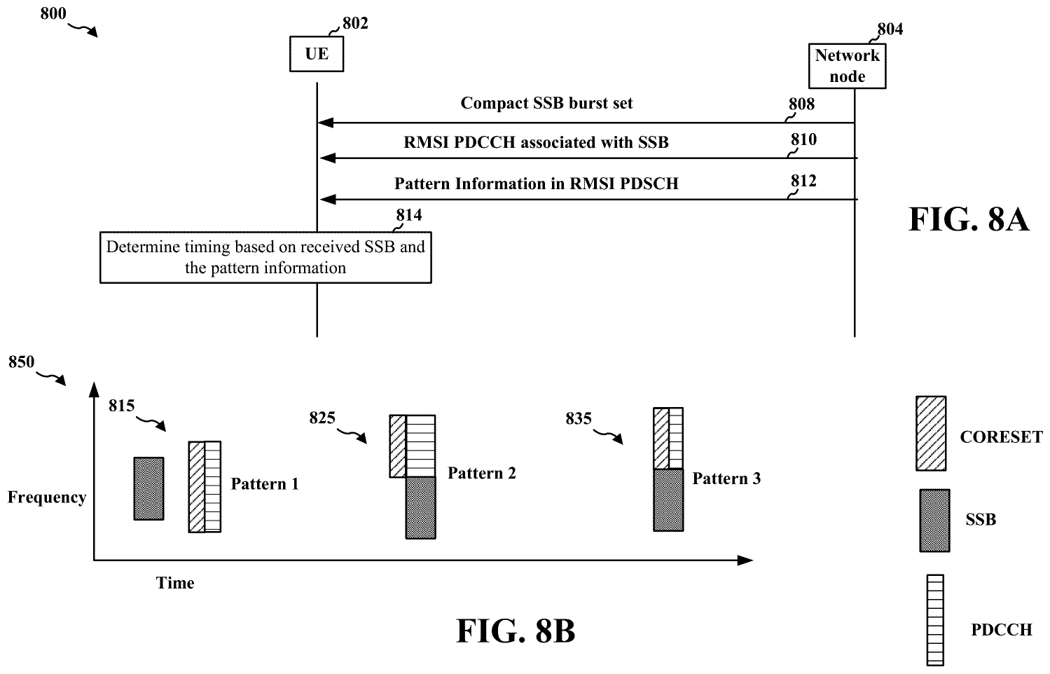

FIG. 8A illustrates an example communication flow 800 between a UE 802 and a network node 804, e.g., that provides a cell. The network node 804 may be a base station (e.g., base station 102, 202, 410) in aggregated form or one or more components of a disaggregated base station, such as a CU 210, DU 230, and/or RU 240. As shown at 808, the network node 804 transmits a compact SSB burst set. At 810, the network node 804 transmits RMSI associated with the SSB that includes provides the UE 802 with pattern information for the compact SSB burst set, e.g., at 808. As shown at 810, the network node may transmit a PDCCH transmission (which may be referred to as an RMSI PDCCH transmission or a PDCCH transmission associated with RMSI). The PDCCH transmission indicates the resources (e.g. time and frequency) in which a PDSCH including RMSI will be transmitted. The UE 802 receives the PDCCH transmission, at 810, and uses the information to receive the PDSCH transmission 812 (which may be referred to as an RMSI PDSCH transmission or a PDSCH transmission associated with RMSI), the PDSCH including the pattern information for the compact SSB burst set 808. As described in connection with FIG. 7A, the pattern information may indicate a pattern from a set of patterns or may indicate one or more parameters that correspond to the pattern. In some aspects, the pattern information for the compact SSB burst set may be signaled to the UE 802 in a SIB, such as SIB1 included in the RMSI, e.g., at 812.

In some aspects, the PDCCH transmission (e.g., 810) for the RMSI may be transmitted with a fixed location (which may be referred to as a defined location or known location) relative to the associated SSB. The UE may receive the PDCCH transmission a monitoring occasion based on the fixed location. The fixed location may be based on a known pattern, such as a defined pattern. FIG. 8B illustrates a time and frequency diagram 850 showing examples of multiplexing patterns in which SSB, PDCCH, and CORESET resources may be multiplexed. In a first pattern 815, the PDCCH and CORESET resources may be time division multiplexed (TDM) with the SSB resources (SSB occasion), and may have a fixed offset relative to the SSB and/or may overlap with the SSB in frequency. In a second pattern 825, the CORESET resources are TDM with the SSB, and the PDCCH resources may be frequency division multiplexed (FDM) with the SSB and overlap in time with the SSB. The PDCCH and/or CORESET resources may have a fixed location relative to the SSB, the CORESET resources are illustrated as being prior to and consecutive in time with the SSB, and the PDCCH resources are shown as being consecutive in frequency with the SSB. In a third pattern 835, the PDCCH resources and the CORESET resources are shown as being FDM with the SSB resources, and overlapping in time with the SSB resources. In some aspects the fixed location relative to the SSB may be based on an offset in frequency (e.g., RBS) and/or in time (e.g., symbols) relative to the associated SSB.

In some aspects, the pattern information may be signaled in the SSB itself, at 808, such as in a MIB the PBCH of the SSB, or an extended MIB.

As shown at 814, the UE can synchronize with the network node 804 by determining timing (e.g., symbol and/or slot timing) for the second cell based on the indicated pattern information in the RMSI and the SSB(s) that the UE received. By accurately determining the timing, the UE 802 is able to synchronize with the network node 804. This enables the UE to receive downlink communication and/or transmit uplink communication with the network node 804, based on the accurately determined timing, e.g., as shown in connection with any of FIGS. 6B, 7A, 7B, for example. As well, accurately determining a slot/symbol timing may enable the UE to correctly determine a DMRS sequence, e.g., for PDCCH and/or PDSCH, which may be based on a slot and/or symbol index.

As described above, without knowledge of the SSB burst set pattern, the UE cannot correctly acquire (e.g., determine or identify) a slot boundary from the SSB index or beam index of a received SSB. In the example in FIG. 8A, as the RMSI PDCCH monitoring occasion has a fixed location with respect to an associated SSB, the UE can use the information carried in the RMSI (e.g., in a PDSCH transmission that indicated by the RMSI PDCCH) to accurately determine the slot and/or symbol index that corresponds to the received SSB index (or beam index of the received SSB).

In some aspects, there might not be a single fixed location (e.g., with a known time and/or frequency offset from the SSB), and the UE may instead monitor for the PDCCH based on a set of multiple PDCCH monitoring occasions (e.g., based on multiple potential offsets in time and/or frequency from the associated SSB). The UE may monitor the multiple PDCCH monitoring occasions to acquire the PDCCH transmission (e.g., RMSI PDCCH or PDCCH carrying the information for the PDSCH transmission carrying the RMSI) and determine the timing (e.g., the slot/symbol boundaries) based on the received SSB. In some aspects, the monitoring for the pattern information in one or more PDCCH monitoring occasions associated with the SSB may be based on a UE capability. In some aspects, the UE 802 may transmit an indication of support for the capability to the network node 804. In some aspects, based on the UE's support for the capability, the network node 804 may transmit a configuration to the UE 802 indicating for the UE to monitor one or more PDCCH monitoring occasions relative to SSB occasions.

The DMRS sequence generation, e.g., for non-compact SSBs may be a function of a slot index and a symbol index. If a UE is not aware of the SSB burst set pattern, e.g., for a compact SSB burst set, the UE may not be able to accurately determine the slot and symbol index, in order to receive and decode the DMRS and obtain the RMSI (e.g., RMSI in PDCCH and/or RMSI in PDSCH).

For example, a DMRS sequence (n) (m)) for PDCCH for OFDM symbol l may be generated based on:

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m - 1 ) ) .$$

where c (i) is a pseudo-random sequence, and the pseudo-random sequence generator is initialized with cᵢₙᵢₜ, where:

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31}$$

where l is the OFDM symbol number within the slot, n_{s,f}^{μ} is the slot number within a frame.

In this example, the DMRS sequence for the PDCCH is based on cᵢₙᵢₜ, which is in turn based on the slot number (e.g., n_{s,f}^{μ}) within the frame and the symbol number (e.g., l) within the slot. In one example, if the UE incorrectly determines the slot or symbol number, the UE will not be able to correctly initialize the sequence generator, and will not be able to correctly decode the DMRS.

For PDSCH, the DMRS sequence r (n) may be generated based on:

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c (i) is determined with a pseudo-random sequence generator initialized with:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} [ \begin{matrix}\overline{λ} \\ \overline{2}\end{matrix} ] + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot, n_{s,f}^{μ} is the slot number within a frame.

In this example, the DMRS sequence for the PDSCH is generated based on an initialization with cᵢₙᵢₜ, which is in turn based on the slot number (e.g., n_{s,f}^{μ}) within the frame and the symbol number (e.g., l) within the slot. If the UE incorrectly determines the slot or symbol number, the UE will not be able to correctly initialize the sequence generator.

In order to enable the UE to correctly receive the DMRS for RMSI (e.g., RMSI in PDCCH and/or RMSI in PDSCH), the DMRS sequence generation may be independent of a slot and/or symbol index. As an example, the initialization based on cᵢₙᵢₜ may be independent of a slot and/or symbol index. This enables the UE to determine the DMRS sequence even in the absence of information about a symbol and/or slot index or if the UE has made an inaccurate determination of a symbol and/or slot index.

As an example, the sequence for DMRS of RMSI PDCCH and/or RMSI PDSCH may initialized based on a fixed value (e.g., rather than based on a symbol and/or slot index. For example, cᵢₙᵢₜ may use a fixed value instead of a slot or symbol index. In some aspects, the fixed value may be defined, preconfigured (e.g., prior to the UE's attempted reception of the RMSI), or otherwise indicated to the UE. In addition to, or as an alternative to, being based on a fixed value, the value for the DMRS scrambling ID may be a function of the SSB index. For example, cᵢₙᵢₜ may use an SSB index instead of a slot or symbol index. For example, the SSB index itself may be used, at least in part, for the DMRS sequence generation. As the UE does not map the SSB index to a slot/symbol and then use the slot/symbol number to generate the DMRS sequence, the UE can receive an SSB, determine the index, and use the SSB index to receive the DMRS.

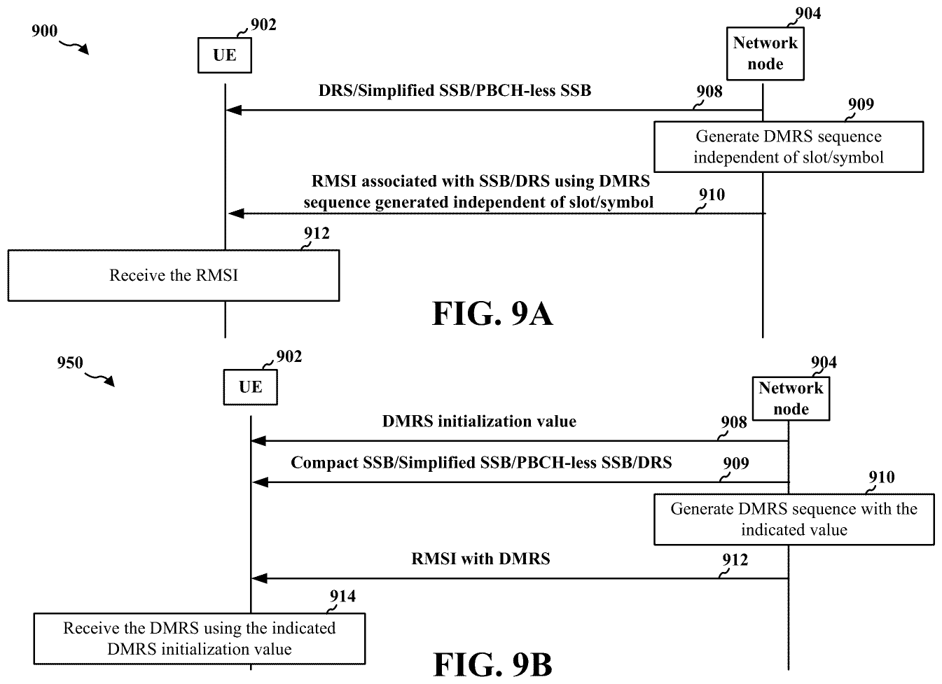

Although the DMRS sequence generation that is independent of a slot and/or symbol is described for RMSI PDCCH and/or PDSCH associated with a compact SSB burst set pattern, the concept is similarly applicable to other types of SSBs and/or reference signals. For example, FIG. 9A illustrates an example communication flow 900 between a UE 902 and a network node 904 in which the network node 904 uses a DMRS sequence generation that is independent of a slot or symbol. The network node 804 may be a base station (e.g., base station 102, 202, 410) in aggregated form or one or more components of a disaggregated base station, such as a CU 210, DU 230, and/or RU 240. As shown at 908, the network node may transmit an SSB, such as a simplified SSB (which has a simplified structure in comparison to the example described in connection with FIG. 3B) or an SSB that does not include a PBCH (which may be referred to as a PBCH-less SSB. In some aspects, the network node may transmit a discovery reference signal (DRS) or other downlink reference signal. The network node 904 scrambles the DMRS sequence generation that is independent of the slot/symbol index. At 910, the network node 904 transmits RMSI (e.g., which may be included in a PDCCH transmission and/or a PDSCH transmissions, such as described in connection with 810 and 812 in FIG. 8A) using a DMRS sequence that is generated independent of a slot and/or symbol index, e.g., as described in connection with FIG. 8A. The initialization value for the DMRS sequence generation may have a fixed value, a configured value, and/or an indicated value. At 912, the UE uses the fixed, configured, or indicated value to receive the RMSI associated with the DRS, simplified SSB, or PBCH-less SSB that was received at 908.

This enables the UE to receive downlink communication and/or transmit uplink communication with the network node 904, based on the accurately determined timing, e.g., as shown in connection with any of FIGS. 6B, 7A, 7B, for example.

FIG. 9B illustrates an example communication flow 950 in which the DMRS scrambling ID may be indicated to the UE 902 by the network node 904, at 908.

At 910, the network node 904 generates a DMRS sequence using an initialization value indicated to the UE at 908, e.g., that is independent of the slot/symbol index. At 912, the network node 904 transmits RMSI (e.g., which may be included in a PDCCH transmission and/or a PDSCH transmissions, such as described in connection with 810 and 812 in FIG. 8A) using a DMRS sequence that is generated using the indicated initialization value. At 914, the UE uses the indicated initialization value to receive the RMSI associated with the DRS or SSB/DRS that was received at 909.

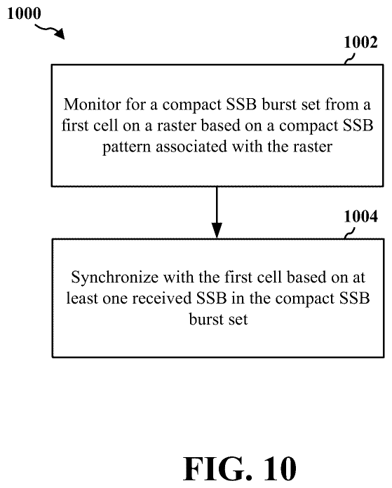

FIG. 10 is a flowchart 1000 of a method of wireless communication. The method may be performed by a UE (e.g., the UE 104, 204, 550, 602, 702, 802, 902; the apparatus 1404). The method enables a UE to accurately synchronize with a network node, or cell, by determining correct timing information associated with an SSB or reference signal, while also enable power savings through the use of a compact SSB burst set.

At 1002, the UE monitors for a compact SSB burst set from a first cell on a raster based on a compact SSB pattern associated with the raster. For example, FIGS. 6B, 7A, 7B, 8A, and 9B illustrate examples of UEs monitoring for SSBs based on a compact SSB burst set. In some aspects, the raster is one of a plurality of synchronization rasters, each synchronization raster having an associated compact SSB pattern. The monitoring for the compact SSB burst set may be performed, e.g., by the compact SSB component 198 of the apparatus 1404, for example. In some aspects, an association between the raster and the compact SSB pattern is defined. In some aspects, the UE may receive an indication of the compact SSB pattern for the raster in a radio resource control (RRC) message from the first cell or a second cell. In some aspects, the UE may receive an indication of the compact SSB pattern for the raster in system information from a second cell. In some aspects, the UE may receive an indication of the compact SSB pattern for the raster in operations, administration, and management (OAM) signaling indicating a burst composition and at least one of a frequency or cell identifier (ID) for each of one or more) cells. In some aspects, the UE may receive, for each of a plurality of frequencies, an indication of an associated compact SSB pattern, wherein the raster for the compact SSB pattern is associated with one of the plurality of frequencies. In some aspects, the associated compact SSB pattern is indicated for each cell operating on a respective frequency.

At 1004, the UE synchronizes with the first cell based on at least one received SSB in the compact SSB burst set. The synchronization may be performed, e.g., by the compact SSB component 198 of the apparatus 1404, for example. In some aspects, as part of synchronizing with the first cell, the UE may determine timing for the first cell, such as a slot or symbol timing, based on the received SSB in view of the compact SSB burst set pattern. In some aspects, the UE may transmit and receive, or monitor for, communication with the first cell using a timing that is determined based on the received SSB(s) and the knowledge of the compact SSB burst set pattern. For example, FIGS. 6B, 7A, 7B, 8A, and 9B illustrate example aspects of UEs synchronizing with cells.

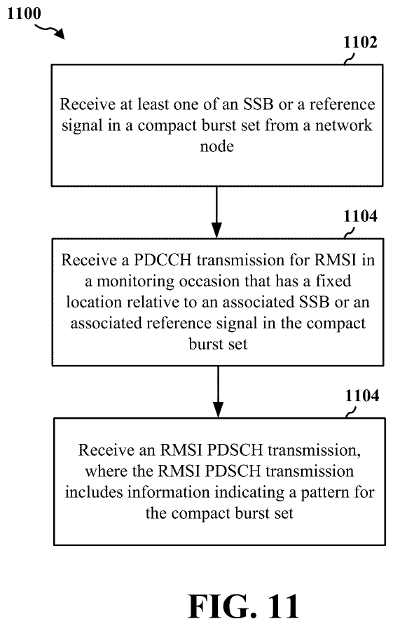

FIG. 11 is a flowchart 1100 of a method of wireless communication. The method may be performed by a UE (e.g., the UE 104, 204, 550, 602, 702, 802, 902; the apparatus 1404). The method enables a UE to accurately receive RMSI even in the absence of a knowledge of timing. This may enable the UE to synchronize with a network node, or cell, by determining correct timing information associated with an SSB or reference signal, while also enable power savings through the use of a compact SSB burst set.

At 1102, the UE receives at least one of an SSB or a reference signal in a compact burst set from a network node. The reception may be performed, e.g., by the compact SSB component 198 of the apparatus 1404, for example. For example, FIGS. 8A, 9A and 9B illustrate examples of UEs receiving an SSB or reference signal.

At 1104, the UE receives a PDCCH transmission for RMSI in a monitoring occasion that has a fixed location relative to an associated SSB or an associated reference signal in the compact burst set. For example, FIGS. 8A, 9A and 9B illustrate examples of UEs receiving RMSI associated with an SSB or reference signal. The reception may be performed, e.g., by the compact SSB component 198 of the apparatus 1404, for example. In some aspects, the SSB is a simplified SSB, and the RMSI is frequency division multiplexed (FDM) with the simplified SSB. In some aspects, the reference signal is a discovery reference signal, and the RMSI is frequency division multiplexed (FDM) with the discovery reference signal. In some aspects, the SSB is without a physical broadcast channel (PBCH) (e.g. PBCH-less) and the RMSI is frequency division multiplexed (FDM) with the SSB. In some aspects, the monitoring occasion is frequency division multiplexed (FDM) with the associated SSB or the associated reference signal.

At 1106, the UE receives an RMSI PDSCH transmission, wherein the RMSI PDSCH transmission includes information indicating a pattern for the compact burst set. The reception may be performed, e.g., by the compact SSB component 198 of the apparatus 1404, for example. In some aspects, the UE may monitor for PDCCH transmission for the RMSI in multiple PDCCH monitoring occasions associated with the SSB or the reference signal. In some aspects, a demodulation reference signal (DMRS) sequence generation for the RMSI on at least one of physical downlink control channel (PDCCH) or a physical downlink shared channel (PDSCH) is independent of a slot index or a symbol index. In some aspects, the DMRS sequence generation for the RMSI is initialized based on a fixed value. In some aspects, the UE may receive an indication of an initialization value for the DMRS sequence generation for the RMSI prior to receiving the RMSI. In some aspects, the DMRS sequence generation for the RMSI is a function of an SSB index of the SSB.

In some aspects, the UE may transmit or receive communication based on timing associated with the SSB in a compact SSB burst set using the pattern indicated in the RMSI. In some aspects, the UE may determine, based on the SSB or the reference signal and the pattern indicated in the RMSI, at least one of a slot index or a symbol index. The determination may be performed, e.g., by the compact SSB component 198 of the apparatus 1404, for example.

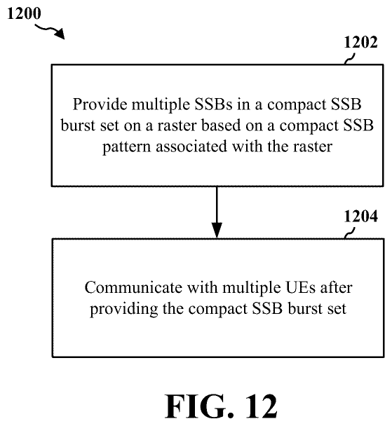

FIG. 12 is a flowchart 1200 of a method of wireless communication. The method may be performed by a base station or one or more components of a base station (e.g., the base station 102, 202; the CU 106, 210; the DU 230; the RU 240; the network entity 1502. The method enables power savings through the use of a compact SSB burst set while continue to enable UEs to synchronize with the network node, or cell.

At 1202, the network node provides multiple synchronization signal blocks (SSBs) in a compact SSB burst set on a raster based on a compact SSB pattern associated with the raster. As an example, the providing of the SSBs may be performed, e.g., by any of the compact SSB component 199, the transceiver 1546, and/or antenna 1580 of the network entity 1502. In some aspects, the raster is one of a plurality of synchronization rasters, each synchronization raster having an associated compact SSB pattern. In some aspects, an association between the raster and the compact SSB pattern is defined. For example, FIGS. 6B, 7A, 7B, 8A, and 9B illustrate examples of a network node providing SSBs based on a compact SSB burst set.

At 1204, the network node communicates with at least one UE after providing the compact SSB burst set. As an example, the communicating may be performed by any of the compact SSB component 199, the transceiver 1546, and/or antenna 1580, e.g., of the network entity 1502. For example, FIGS. 6B, 7A, 7B, 8A, and 9B illustrate examples of a network node communicating with a UE after transmission of an SSB.

In some aspects, the network node may further provide an indication of the compact SSB pattern for the raster in one or more of: a RRC message from the cell or a second cell. system information, or OAM signaling indicating a frequency, cell ID, and burst composition for each of one or more cells. For example, FIGS. 7A, 7B, and 8A illustrate examples of a network node providing an indication of pattern information.

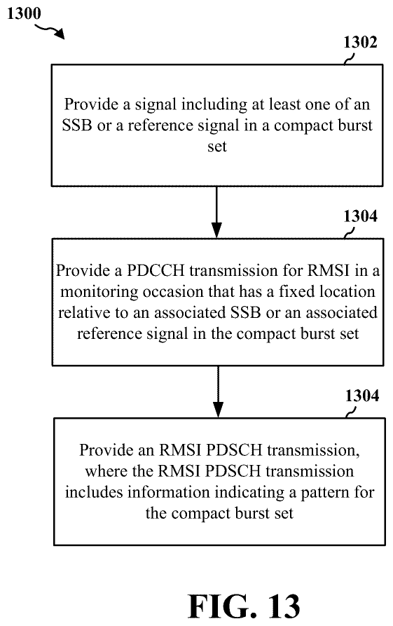

FIG. 13 is a flowchart 1300 of a method of wireless communication. The method may be performed by a base station or one or more components of a base station (e.g., the base station 102, 202; the CU 106, 210; the DU 230; the RU 240; the network entity 1502. The method enables a network node to transmit RMSI that can be received by UEs even in the absence of a knowledge of timing. This may enable the UE to synchronize with a network node, or cell, by determining correct timing information associated with an SSB or reference signal, while also enable power savings through the use of a compact SSB burst set, simplified SSB, PBCH-less SSB, or other downlink reference signal, for example.

At 1302, the network node provides a signal including at least one of an SSB or a reference signal in a compact burst set. As an example, the providing of the SSB or the reference signal may be performed by any of the compact SSB component 199, the transceiver 1546, and/or antenna 1580, e.g., of the network entity 1502. In some aspects, the signal includes a compact SSB burst set, a simplified SSB, or the SSB without a PBCH, or a discovery reference signal. For example, FIGS. 8A, 9A and 9B illustrate examples of UEs receiving an SSB or reference signal.

At 1304, the network node provides a PDCCH transmission for RMSI in a monitoring occasion that has a fixed location relative to an associated SSB or an associated reference signal in the compact burst set. As an example, the providing may be performed by any of the compact SSB component 199, the transceiver 1546, and/or antenna 1580, e.g., of the network entity 1502. In some aspects, the monitoring occasion for the RMSI is FDM with the associated SSB or the associated reference signal. For example, FIG. 8A illustrates an example of a network node providing an RMSI PDCCH associated with a SSB.

At 1306, the network node provides an RMSI PDSCH transmission, where the RMSI PDSCH transmission includes information indicating a pattern for the compact burst set. As an example, the providing of the SSB or the reference signal may be performed by any of the compact SSB component 199, the transceiver 1546, and/or antenna 1580, e.g., of the network entity 1502. In some aspects, a demodulation reference signal (DMRS) sequence generation for the RMSI on at least one of physical downlink control channel (PDCCH) or a physical downlink shared channel (PDSCH) is independent of a slot index or a symbol index. In some aspects, the DMRS sequence generation for the RMSI is initialized based on a fixed value. In some aspects, the network node provides an indication of an initialization value for the DMRS sequence generation for the RMSI prior to receiving the RMSI. In some aspects, the DMRS sequence generation for the RMSI is a function of an SSB index of the SSB. For example, FIGS. 8A, 9A and 9B illustrate examples of a network node providing RMSI associated with an SSB or reference signal.

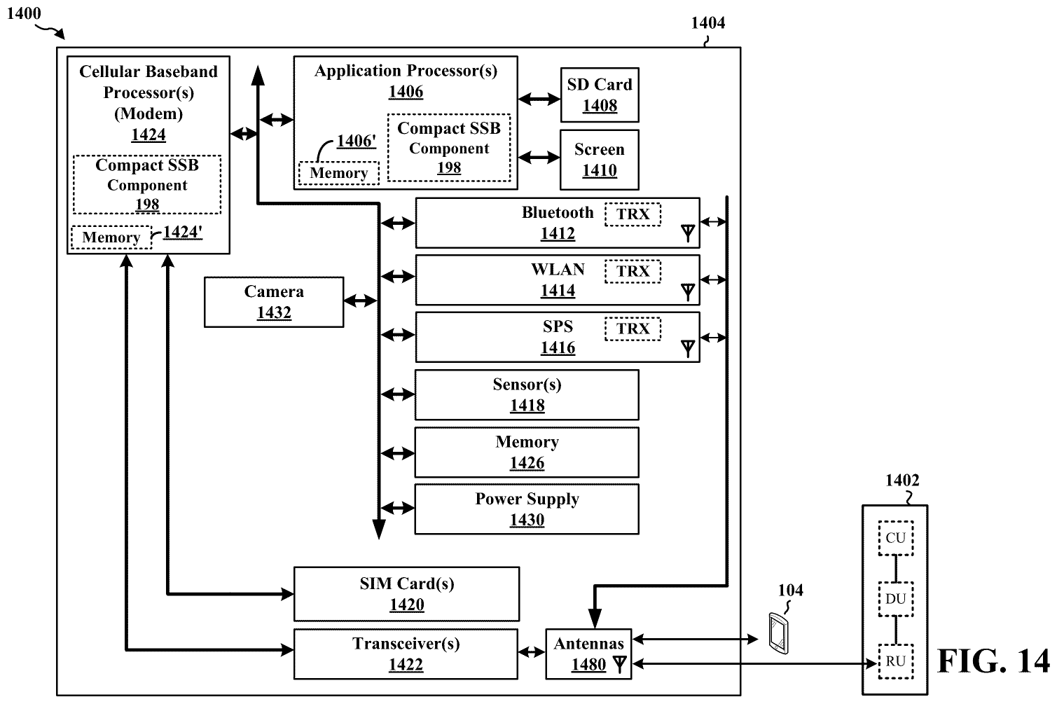

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 450 and may include the at least one memory 460 and/or at least one of the TX processor 468, the RX processor 456, and the controller/processor 459. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 450 of FIG. 4) and include the additional modules of the apparatus 1404.

As discussed supra, the component 198 may be configured to monitor for a compact SSB burst set from a first cell on a raster based on a compact SSB pattern associated with the raster; and synchronize with the first cell based on at least one received SSB in the compact SSB burst set. In some aspects, the compact SSB component 198 may be configured to receive an indication of the compact SSB pattern for the raster in a radio resource control (RRC) message from the first cell or a second cell. In some aspects, the compact SSB component 198 may be configured to receive an indication of the compact SSB pattern for the raster in system information from a second cell. In some aspects, the compact SSB component 198 may be configured to receive an indication of the compact SSB pattern for the raster in operations, administration, and management (OAM) signaling indicating a burst composition and at least one of a frequency or cell identifier (ID) for each of one or more) cells. In some aspects, the compact SSB component 198 may be configured to receive, for each of a plurality of frequencies, an indication of an associated compact SSB pattern, wherein the raster for the compact SSB pattern is associated with one of the plurality of frequencies. In some aspects, the compact SSB component 198 may be configured to receive at least one of a synchronization signal block (SSB) or a reference signal in a compact burst set from a network node; receive a PDCCH transmission for RMSI in a monitoring occasion that has a fixed location relative to an associated SSB or an associated reference signal in the compact burst set; and receive an RMSI PDSCH transmission, wherein the RMSI PDSCH transmission includes information indicating a pattern for the compact burst set. In some aspects, the compact SSB component 198 may be configured to transmit or receive communication based on timing associated with the SSB in a compact SSB burst set using the pattern indicated in the RMSI. In some aspects, the compact SSB component 198 may be configured to determine, based on the SSB or the reference signal and the pattern indicated in the RMSI, at least one of a slot index or a symbol index. In some aspects, the compact SSB component 198 may be configured to monitor for PDCCH transmission for the RMSI in multiple PDCCH monitoring occasions associated with the SSB or the reference signal. In some aspects, the compact SSB component 198 may be configured to receive an indication of an initialization value for the DMRS sequence generation for the RMSI prior to receiving the RMSI. The compact SSB component 198 may be further configured to perform any of the aspects described in connection with the flowchart in FIGS. 10 and/or 11, and/or any of the aspects performed by the UE in any of FIGS. 6B, 7A, 8A, 9A, and/or 9B. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for monitoring for a compact SSB burst set from a first cell on a raster based on a compact SSB pattern associated with the raster; and means for synchronizing with the first cell based on at least one received SSB in the compact SSB burst set. The apparatus may include means for receiving at least one of a synchronization signal block (SSB) or a reference signal in a compact burst set from a network node; means for receiving a PDCCH transmission for RMSI in a monitoring occasion that has a fixed location relative to an associated SSB or an associated reference signal in the compact burst set; and means for receiving an RMSI PDSCH transmission, wherein the RMSI PDSCH transmission includes information indicating a pattern for the compact burst set. The apparatus may further include means for receiving an indication of the compact SSB pattern for the raster in a radio resource control (RRC) message from the first cell or a second cell. The apparatus may further include means for receiving an indication of the compact SSB pattern for the raster in system information from a second cell. The apparatus may further include means for receiving an indication of the compact SSB pattern for the raster in operations, administration, and management (OAM) signaling indicating a burst composition and at least one of a frequency or cell identifier (ID) for each of one or more) cells. The apparatus may further include means for receiving, for each of a plurality of frequencies, an indication of an associated compact SSB pattern, wherein the raster for the compact SSB pattern is associated with one of the plurality of frequencies. The apparatus may further include means for transmitting or receiving communication based on timing associated with the SSB in a compact SSB burst set using the pattern indicated in the RMSI. The apparatus may further include means for determining, based on the SSB or the reference signal and the pattern indicated in the RMSI, at least one of a slot index or a symbol index. The apparatus may further include means for monitoring for PDCCH transmission for the RMSI in multiple PDCCH monitoring occasions associated with the SSB or the reference signal. The apparatus may further include means for receiving an indication of an initialization value for the DMRS sequence generation for the RMSI prior to receiving the RMSI. The apparatus may further include means for performing any of the aspects described in connection with the flowchart in FIGS. 10 and/or 11, and/or any of the aspects performing by the UE in any of FIGS. 6B, 7A, 8A, 9A, and/or 9B. The means may be the component 198 of the apparatus 1404 configured to perform the functions recited by the means. As described supra, the apparatus 1404 may include the TX processor 468, the RX processor 456, and the controller/processor 459. As such, in one configuration, the means may be the TX processor 468, the RX processor 456, and/or the controller/processor 459 configured to perform the functions recited by the means.

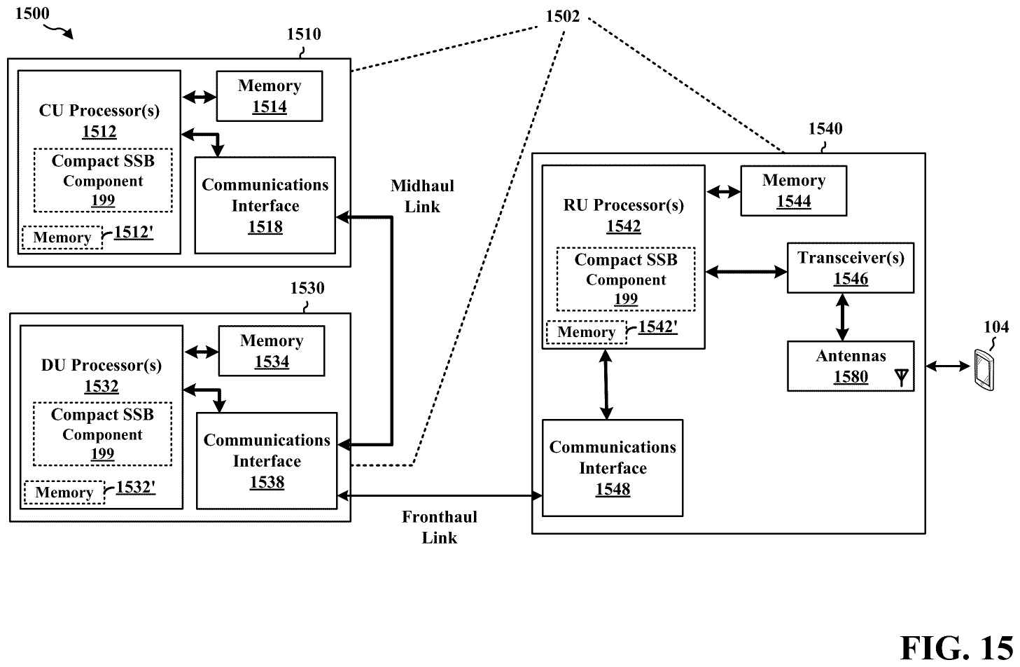

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide multiple synchronization signal blocks (SSBs) in a compact SSB burst set on a raster based on a compact SSB pattern associated with the raster; and communicate with at least one UE after providing the compact SSB burst set. The compact SSB component 199 may be further configured to provide an indication of the compact SSB pattern for the raster in one or more of: a radio resource control (RRC) message from the cell or a second cell. system information, or operations, administration, and management (OAM) signaling indicating a frequency, cell identifier (ID), and burst composition for each of one or more cells. In some aspects, the compact SSB component 199 may be configured to provide a signal including at least one of a synchronization signal block (SSB) or a reference signal in a compact burst set; provide a PDCCH transmission for RMSI in a monitoring occasion that has a fixed location relative to an associated SSB or an associated reference signal in the compact burst set; and provide an RMSI PDSCH transmission, wherein the RMSI PDSCH transmission includes information indicating a pattern for the compact burst set. The compact SSB component 199 may be further configured to perform any of the aspects described in connection with the flowchart in FIGS. 12 and/or 13, and/or any of the aspects performed by a cell or network node in any of FIGS. 6B, 7A, 8A, 9A, and/or 9B. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for providing multiple synchronization signal blocks (SSBs) in a compact SSB burst set on a raster based on a compact SSB pattern associated with the raster; and means for communicating with at least one UE after providing the compact SSB burst set. The apparatus may further include means for providing an indication of the compact SSB pattern for the raster in one or more of: a radio resource control (RRC) message from the cell or a second cell. system information, or operations, administration, and management (OAM) signaling indicating a frequency, cell identifier (ID), and burst composition for each of one or more cells. The network entity 1502 may include means for providing a signal including at least one of a synchronization signal block (SSB) or a reference signal in a compact burst set; means for providing a PDCCH transmission for RMSI in a monitoring occasion that has a fixed location relative to an associated SSB or an associated reference signal in the compact burst set; and means for providing an RMSI PDSCH transmission, wherein the RMSI PDSCH transmission includes information indicating a pattern for the compact burst set. The network entity may further include means for performing any of the aspects described in connection with the flowchart in FIGS. 12 and/or 13, and/or any of the aspects performed by a cell or network node in any of FIGS. 6B, 7A, 8A, 9A, and/or 9B. The means may be the component 199 of the network entity 1502 configured to perform the functions recited by the means. As described supra, the network entity 1502 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: monitoring for a compact synchronization signal blocks (SSB) burst set from a first cell on a raster based on a compact SSB pattern associated with the raster; and synchronizing with the first cell based on at least one received SSB in the compact SSB burst set.

Aspect 2 is a method of aspect 1, wherein the raster is one of a plurality of synchronization rasters, each synchronization raster having an associated compact SSB pattern.

Aspect 3 is a method of aspect 1 or aspect 2, wherein an association between the raster and the compact SSB pattern is defined.

Aspect 4 is a method of aspect 1 or aspect 2, further comprising: receiving an indication of the compact SSB pattern for the raster in a radio resource control (RRC) message from the first cell or a second cell.

Aspect 5 is a method of any of aspects 1, 2, or 4, further comprising: receiving an indication of the compact SSB pattern for the raster in system information from a second cell.

Aspect 6 is a method of aspects 1, 2, 4, or 5, further comprising: receiving an indication of the compact SSB pattern for the raster in operations, administration, and management (OAM) signaling indicating a burst composition and at least one of a frequency or cell identifier (ID) for each of one or more) cells.

Aspect 7 is a method of any of aspects 1, 2, 4, 5, or 6, further comprising: receiving, for each of a plurality of frequencies, an indication of an associated compact SSB pattern, wherein the raster for the compact SSB pattern is associated with one of the plurality of frequencies.

Aspect 8 is a method of aspect 7, wherein the associated compact SSB pattern is indicated for each cell operating on a respective frequency.

Aspect 9 is a method of wireless communication at a user equipment (UE), comprising: receiving at least one of a synchronization signal block (SSB) or a reference signal in a compact burst set from a network node; receiving a physical downlink control channel (PDCCH) transmission for remaining system information (RMSI) in a monitoring occasion that has a fixed location relative to an associated SSB or an associated reference signal in the compact burst set; and receiving an RMSI physical downlink shared channel (PDSCH) transmission, wherein the RMSI PDSCH transmission includes information indicating a pattern for the compact burst set.

Aspect 10 is a method of aspect 9, the method further comprising: transmitting or receiving communication based on timing associated with the SSB in a compact SSB burst set using the pattern indicated in the RMSI.

Aspect 11 is a method of aspect 9 or 10, wherein synchronizing with the network node includes determining, based on the SSB or the reference signal and the pattern indicated in the RMSI, at least one of a slot index or a symbol index.

Aspect 12 is a method of any of aspects 9-11, wherein the SSB is a simplified SSB, and the RMSI is frequency division multiplexed (FDM) with the simplified SSB.

Aspect 13 is a method of any of aspects 9-11, wherein the reference signal is a discovery reference signal, and the RMSI is frequency division multiplexed (FDM) with the discovery reference signal.

Aspect 14 is a method of any of aspects 9-11, wherein the SSB is without a physical broadcast channel (PBCH) and the RMSI is frequency division multiplexed (FDM) with the SSB.

Aspect 15 is a method of any of aspects 9-14, wherein the monitoring occasion is frequency division multiplexed (FDM) with the associated SSB or the associated reference signal.

Aspect 16 is a method of any of aspects 9-15, further comprising: monitoring for PDCCH transmission for the RMSI in multiple physical downlink control channel (PDCCH) monitoring occasions associated with the SSB or the reference signal.

Aspect 17 is a method of any of aspects 9-16, wherein a demodulation reference signal (DMRS) sequence generation for the RMSI on at least one of physical downlink control channel (PDCCH) or a physical downlink shared channel (PDSCH) is independent of a slot index or a symbol index.

Aspect 18 is a method of aspect 17, wherein the DMRS sequence generation for the RMSI is initialized based on a fixed value.

Aspect 19 is a method of aspect 17, further comprising: receiving an indication of an initialization value for the DMRS sequence generation for the RMSI prior to receiving the RMSI.

Aspect 20 is a method of aspect 17, wherein the DMRS sequence generation for the RMSI is a function of an SSB index of the SSB.

Aspect 21 is a method of wireless communication at a network node, comprising: providing multiple synchronization signal blocks (SSBs) in a compact SSB burst set on a raster based on a compact SSB pattern associated with the raster; and communicating with at least one user equipment (UE) after providing the compact SSB burst set.

Aspect 22 is a method of aspect 21, wherein the raster is one of a plurality of synchronization rasters, each synchronization raster having an associated compact SSB pattern.

Aspect 23 is a method of aspect 21 or 22, wherein an association between the raster and the compact SSB pattern is defined.

Aspect 24 is a method of aspect 21 or 22, further comprising: providing an indication of the compact SSB pattern for the raster in one or more of: a radio resource control (RRC) message from the cell or a second cell. system information, or operations, administration, and management (OAM) signaling indicating a frequency, cell identifier (ID), and burst composition for each of one or more cells.

Aspect 25 is a method of wireless communication at a network node, comprising: providing a signal including at least one of a synchronization signal block (SSB) or a reference signal in a compact burst set; providing a physical downlink control channel (PDCCH) transmission for remaining system information (RMSI) in a monitoring occasion that has a fixed location relative to an associated SSB or an associated reference signal in the compact burst set; and providing an RMSI physical downlink shared channel (PDSCH) transmission, wherein the RMSI PDSCH transmission includes information indicating a pattern for the compact burst set.

Aspect 26 is a method of aspect 25 wherein the signal includes a compact SSB burst set, a simplified SSB, or the SSB without a physical broadcast channel (PBCH), or a discovery reference signal.

Aspect 27 is a method of aspect 25 or 26, wherein the monitoring occasion for the RMSI is frequency division multiplexed (FDM) with the associated SSB or the associated reference signal.

Aspect 28 is a method of any of aspects 25-27, wherein a demodulation reference signal (DMRS) sequence generation for the RMSI on at least one of physical downlink control channel (PDCCH) or a physical downlink shared channel (PDSCH) is independent of a slot index or a symbol index.

Aspect 29 is a method of any of aspects 25-28, wherein the DMRS sequence generation for the RMSI is initialized based on a fixed value.

Aspect 30 is a method of any of aspects 25-28 further comprising providing an indication of an initialization value for the DMRS sequence generation for the RMSI prior to receiving the RMSI.

Aspect 31 is a method of any of aspects 25-28, wherein the DMRS sequence generation for the RMSI is a function of an SSB index of the SSB.

Aspect 32 is an apparatus for wireless communication at a UE, comprising: one or more memories; and one or more processors coupled to the one or more memories and configured to cause the UE to perform the method of any of aspects 1-8.

Aspect 33 is an apparatus for wireless communication at a UE, comprising means for performing each step in the method of any of aspects 1-8.

Aspect 34 is a UE comprising: a processing system that includes processor circuitry and memory circuitry that stores code and is coupled with the processor circuitry, the processing system configured to cause the UE to perform the method of any of aspects 1-8.

Aspect 35 is the apparatus of any of aspects 32 to 34, further comprising a transceiver configured to receive or to transmit in association with the method of any of aspects 1-8.

Aspect 36 is a computer-readable storage medium (e.g., a non-transitory computer-readable storage medium) storing computer executable code at a UE, the code when executed by at least one processor causes the UE to perform the method of any of aspects 1-8.

Aspect 37 is an apparatus for wireless communication at a UE, comprising: one or more memories; and one or more processors coupled to the one or more memories and configured to cause the UE to perform the method of any of aspects 9-20.

Aspect 38 is an apparatus for wireless communication at a UE, comprising means for performing each step in the method of any of aspects 9-20.

Aspect 39 is a UE comprising: a processing system that includes processor circuitry and memory circuitry that stores code and is coupled with the processor circuitry, the processing system configured to cause the UE to perform the method of any of aspects 9-20.

Aspect 40 is the apparatus of any of aspects 37 to 39, further comprising a transceiver configured to receive or to transmit in association with the method of any of aspects 9-20.

Aspect 41 is a computer-readable storage medium (e.g., a non-transitory computer-readable storage medium) storing computer executable code at a UE, the code when executed by at least one processor causes the UE to perform the method of any of aspects 9-20.

Aspect 42 is an apparatus for wireless communication at a network node, comprising: one or more memories; and one or more processors coupled to the one or more memories and configured to cause the network node to perform the method of any of aspects 21-24.

Aspect 43 is an apparatus for wireless communication at a network node, comprising means for performing each step in the method of any of aspects 21-24.

Aspect 44 is network entity comprising: a processing system that includes processor circuitry and memory circuitry that stores code and is coupled with the processor circuitry, the processing system configured to cause the network entity to: perform the method of any of aspects 21-24.

Aspect 45 is the apparatus of any of aspects 42 to 44, further comprising a transceiver configured to receive or to transmit in association with the method of any of aspects 9-20.

Aspect 46 is a computer-readable storage medium (e.g., a non-transitory computer-readable storage medium) storing computer executable code at a network node, the code when executed by at least one processor causes the network node to perform the method of any of aspects 9-20.

Aspect 47 is an apparatus for wireless communication at a network node, comprising: one or more memories; and one or more processors coupled to the one or more memories and configured to cause the network node to perform the method of any of aspects 25-31.

Aspect 48 is network entity comprising: a processing system that includes processor circuitry and memory circuitry that stores code and is coupled with the processor circuitry, the processing system configured to cause the network entity to: perform the method of any of aspects 25-31.

Aspect 49 is an apparatus for wireless communication at a network node, comprising means for performing each step in the method of any of aspects 25-31.

Aspect 50 is the apparatus of any of aspects 47 to 49, further comprising a transceiver configured to receive or to transmit in association with the method of any of aspects 25-31.

Aspect 51 is a computer-readable storage medium (e.g., a non-transitory computer-readable storage medium) storing computer executable code at a network node, the code when executed by at least one processor causes the network node to perform the method of any of aspects 25-31.

What is claimed is:

1. An apparatus for wireless communication at a user equipment (UE), comprising:
one or more memories; and
one or more processors coupled to the one or more memories and configured to cause the UE to:
receive at least one of a synchronization signal block (SSB) or a reference signal in a compact burst set from a network node;
receive a physical downlink control channel (PDCCH) transmission for remaining system information (RMSI) in a monitoring occasion that has a fixed location relative to an associated SSB or an associated reference signal in the compact burst set; and
receive an RMSI physical downlink shared channel (PDSCH) transmission, wherein the RMSI PDSCH transmission includes information indicating a pattern for the compact burst set.

2. The apparatus of claim 1, wherein the one or more processors are further configured to cause the UE to:
transmit or receive communication based on timing associated with the SSB in a compact SSB burst set using the pattern indicated in the RMSI.

3. The apparatus of claim 2, wherein to synchronize with the network node, the one or more processors are configured to cause the UE to:
determine based on the SSB or the reference signal and the pattern indicated in the RMSI, at least one of a slot index or a symbol index.

4. The apparatus of claim 1, wherein the SSB is a simplified SSB, and the RMSI is frequency division multiplexed (FDM) with the simplified SSB.

5. The apparatus of claim 1, wherein the reference signal is a discovery reference signal, and the RMSI is frequency division multiplexed (FDM) with the discovery reference signal.

6. The apparatus of claim 1, wherein the SSB is without a physical broadcast channel (PBCH) and the RMSI is frequency division multiplexed (FDM) with the SSB.

7. The apparatus of claim 1, wherein the monitoring occasion is frequency division multiplexed (FDM) with the associated SSB or the associated reference signal.

8. The apparatus of claim 1, wherein the one or more processors are further configured to cause the UE to:
monitor for PDCCH transmission for the RMSI in multiple physical downlink control channel (PDCCH) monitoring occasions associated with the SSB or the reference signal.

9. The apparatus of claim 1, wherein a demodulation reference signal (DMRS) sequence generation for the RMSI on at least one of physical downlink control channel (PDCCH) or a physical downlink shared channel (PDSCH) is independent of a slot index or a symbol index.

10. The apparatus of claim 9, wherein the DMRS sequence generation for the RMSI is initialized based on a fixed value.

11. The apparatus of claim 9, wherein the one or more processors are further configured to cause the UE to:
receive an indication of an initialization value for the DMRS sequence generation for the RMSI prior to receiving the RMSI.

12. The apparatus of claim 9, wherein the DMRS sequence generation for the RMSI is a function of an SSB index of the SSB.

13. An apparatus for wireless communication at a user equipment (UE), comprising:
one or more memories; and
one or more processors coupled to the one or more memories and configured to cause the UE to:
monitor for a compact synchronization signal blocks (SSB) burst set from a first cell on a raster based on a compact SSB pattern associated with the raster; and
synchronize with the first cell based on at least one received SSB in the compact SSB burst set.

14. The apparatus of claim 13, wherein the raster is one of a plurality of synchronization rasters, each synchronization raster having an associated compact SSB pattern.

15. The apparatus of claim 13, wherein an association between the raster and the compact SSB pattern is defined.

16. The apparatus of claim 13, wherein the one or more processors are further configured to cause the UE to:
receive an indication of the compact SSB pattern for the raster in a radio resource control (RRC) message from the first cell or a second cell.

17. The apparatus of claim 13, wherein the one or more processors are further configured to cause the UE to:
receive an indication of the compact SSB pattern for the raster in system information from a second cell.

18. The apparatus of claim 13, wherein the one or more processors are further configured to cause the UE to:
receive an indication of the compact SSB pattern for the raster in operations, administration, and management (OAM) signaling indicating a burst composition and at least one of a frequency or cell identifier (ID) for each of one or more) cells.

19. The apparatus of claim 13, wherein the one or more processors are further configured to cause the UE to:
receive, for each of a plurality of frequencies, an indication of an associated compact SSB pattern, wherein the raster for the compact SSB pattern is associated with one of the plurality of frequencies.

20. The apparatus of claim 19, wherein the associated compact SSB pattern is indicated for each cell operating on a respective frequency.

21. An apparatus for wireless communication at a network node, comprising:
one or more memories; and
one or more processors coupled to the one or more memories, the one or more processors configured to cause the network node to:
provide a signal including at least one of a synchronization signal block (SSB) or a reference signal in a compact burst set;
provide a physical downlink control channel (PDCCH) transmission for remaining system information (RMSI) in a monitoring occasion that has a fixed location relative to an associated SSB or an associated reference signal in the compact burst set; and
provide an RMSI physical downlink shared channel (PDSCH) transmission, wherein the RMSI PDSCH transmission includes information indicating a pattern for the compact burst set.

22. The apparatus of claim 21 wherein the signal includes a compact SSB burst set, a simplified SSB, or the SSB without a physical broadcast channel (PBCH), or a discovery reference signal.

23. The apparatus of claim 21, wherein the monitoring occasion for the RMSI is frequency division multiplexed (FDM) with the associated SSB or the associated reference signal.

24. The apparatus of claim 21, wherein a demodulation reference signal (DMRS) sequence generation for the RMSI on at least one of physical downlink control channel (PDCCH) or a physical downlink shared channel (PDSCH) is independent of a slot index or a symbol index.

25. The apparatus of claim 24, wherein the DMRS sequence generation for the RMSI is initialized based on a fixed value, or wherein the one or more processors are further configured to cause the network node to provide an indication of an initialization value for the DMRS sequence generation for the RMSI prior to receiving the RMSI.

26. The apparatus of claim 24, wherein the DMRS sequence generation for the RMSI is a function of an SSB index of the SSB.

27. An apparatus for wireless communication at a network node, comprising:
one or more memories; and
one or more processors coupled to the one or more memories, the one or more processors are configured to cause the network node to:
provide multiple synchronization signal blocks (SSBs) in a compact SSB burst set on a raster based on a compact SSB pattern associated with the raster; and
communicate with at least one user equipment (UE) after providing the compact SSB burst set.

28. The apparatus of claim 27, wherein the raster is one of a plurality of synchronization rasters, each synchronization raster having an associated compact SSB pattern.

29. The apparatus of claim 27, wherein an association between the raster and the compact SSB pattern is defined.

30. The apparatus of claim 27, wherein the one or more processors are further configured to cause the network node to:
provide an indication of the compact SSB pattern for the raster in one or more of:
a radio resource control (RRC) message,
system information, or
operations, administration, and management (OAM) signaling indicating a frequency, cell identifier (ID), and burst composition for each of one or more cells.
